(19) United States
(12) Patent Application Publication
(10) Pub. No.: US 2016/0093020 A1
(43) Pub. Date: Mar. 31, 2016

(54) METHOD OF PROCURING INTEGRATING AND SHARING SELF PORTRAITS FOR A SOCIAL NETWORK

(71) Applicant: UMM AL-QURA UNIVERSITY, Makkah (SA)

(72) Inventors: Anas BASALAMAH, Makkah (SA); Saleh BASALAMAH, Makkah (SA); Mostafa ELGANAINY, Makkah (SA); Mohamed Mostafa Mohamed Abdelghany DAOUD, Makkah (SA)

(73) Assignee: UMM AL-QURA UNIVERSITY, Makkah (SA)

(21) Appl. No.: 14/870,427

(22) Filed: Sep. 30, 2015

Related U.S. Application Data
(60) Provisional application No. 62/057,242, filed on Sep. 30, 2014.
(60) Provisional application No. 62/169,340, filed on Jun. 1, 2015.

(51) Int. Cl. G06T 3/40; G06F 3/0484; H04N 5/225; G06F 3/0482; G06T 7/00; G06K 9/00

(52) U.S. Cl. CPC G06T 3/4038; G06T 3/403; G06T 7/0085; G06T 7/0097; G06K 9/00221; H04N 5/225; G06F 3/0482; G06F 3/04842; G06F 3/04845; G06T 2207/10024; G06T 2207/20221; G06T 2207/30201

(57) ABSTRACT

An apparatus and method for combining contributed images from a plurality of imaging devices on a network to create a combined image, such as a group selfie. A group-selfie request is initiated inviting selected network users to contribute images. After receiving the contributed images, sub-images are selected from the contributed images and arranged within a combined image. The border around each sub-image is then blended into the combined image. The sub-images can also be filtered and modified to harmonize with the combined image. Further, each sub-image from the respective contributed image can be assigned to a predefined partition of the combined image, and the sub-images can be continuously updated from the respective contributing network users to provide a real-time combined image.

### CROSS-REFERENCE TO RELATED APPLICATIONS

This application is based upon and claims the benefit of priority from U.S. Provisional Application Ser. No. 62/057,242, filed Sep. 30, 2014, and from U.S. Provisional Application Ser. No. 62/169,340, filed Jun. 1, 2015, the entire contents of each of which are incorporated herein by reference.

### BACKGROUND

1. Field

The disclosure generally relates to a method whereby a digital camera user, such as a smart-phone user, interacts over a network with other users to combine digital images of each of the users into a combined digital image including a sub-image from each user.

2. Description of the Related Art

A selfie is a self-portrait photograph, typically taken with a hand-held digital camera, such as a camera phone. Selfies are often shared on social networking services such as Facebook®, Instagram®, Snapchat®, Tumblr®, and Twitter®. They are often casual, and are conventionally taken either with a camera held at arm's length or in a mirror. Taking Selfie photos is becoming a very popular social activity throughout the world. Many people like to add a message to the photo by annotating few words, pictograms, or hand drawings, to be saved and shared. A selfie can be for a person by himself or a group of people as long as they can fit within the camera's viewing frame.

### SUMMARY

According to aspects of the disclosure, there is provided a method of obtaining a group image, the method comprising: (i) sending, through a network, an image-request message to a plurality of selected users; (ii) receiving, in response to the image-request message, a plurality of contributed images from the plurality of selected users; (iii) selecting a plurality of sub-images from the plurality of contributed images, wherein each sub-image corresponds to a sub-image area within the respective contributed image; and (iv) combining the plurality of sub-images, using processing circuitry, to create a combined image by arranging the plurality of sub-images within the combined image and blending a boundary region of each sub-image with the combined image.

According to another aspect, the method further includes that (i) the step of selecting the plurality of sub-images further includes that the combined image is divided into a plurality of partitions assigned to respective sub-images, and each sub-image area of the respective sub-image has a predefined shape within the respective contributed image determined by the respective partition of the combined image, (ii) the combined image is continuously updated to represent a real-time image, wherein the plurality of contributed images are continuously received and the sub-images are continuously updated and combined to create the combined image representing a real-time composite of the contributed images from the plurality of selected users, and (iii) the step of selecting the plurality of sub-images includes detecting faces in a contributed image of the plurality of contributed images and defining a region localized around each detected face as a facial area, and selecting at least one of the facial areas as the sub-image area of the contributed image.

According to another aspect, the method further includes: (i) filtering the plurality of sub-images to harmonize a color and a dark level of the plurality of sub-images with the combined image, (ii) adjusting the shape and size of each of the plurality of sub-images to harmonize objects represented in the plurality of sub-images with shapes and sizes of objects represented in the combined image, (iii) adjusting the width of the boundary region of each sub-image; (iv) selecting a blending method whereby the boundary region of each sub-image is blended with the combined image, and (v) arranging the plurality of sub-images within the combined image to minimize the overlap among the plurality of sub-images.

According to aspects of the disclosure, there is provided an apparatus for combining images, comprising: (i) an interface connectable to a network; and (ii) processing circuitry configured to (1) send an image request to a plurality of selected users, (2) receive a plurality of contributed images from the plurality of selected users, (3) select a plurality of sub-images from the plurality of contributed images, wherein each sub-image corresponds to a sub-image area within the respective contributed image, and (4) combine the plurality of sub-images to create a combined image by arranging the plurality of sub-images within the combined image and blending a boundary region of each sub-image with the combined image.

### BRIEF DESCRIPTION OF THE DRAWINGS

A more complete understanding of this disclosure is provided by reference to the following detailed description when considered in connection with the accompanying drawings, wherein:

FIG. 1A shows a flow chart of an example of a method to combine images from individual network users to create a combined image;

FIG. 1B shows a flow chart of an example of a method to create a combined image from individual users' images using a home screen with menu options;

FIG. 1C shows a flow chart of an example of a method to create a real-time combined image from individual users' real-time images;

FIG. 1D shows a flow chart of an example of a process to create a real-time combined image;

FIG. 1E shows a flow chart of an example of a process to access image-editing features from a home screen with menu options;

FIG. 2A shows an example of a drawing of a “splash” screen on a user device;

FIG. 2B shows an example of a drawing of a “login” screen on a user device;

FIG. 2C shows an example of a drawing of a “sign up” screen on a user device;

FIG. 2D shows an example of a drawing of a “contacts” screen on a user device;

FIG. 2E shows an example of a drawing of a “stored image icon” screen on a user device;

FIG. 2F shows an example of a drawing of a “scroll/view image” screen on a user device;

FIG. 2G shows an example of a drawing of an “acquire image” screen on a user device;

FIG. 2H shows an example of a drawing of a “filter” screen on a user device;

FIG. 2I shows an example of a drawing of an “annotation” screen on a user device;

FIG. 2J shows an example of a drawing of a “combine images” screen on a user device;

FIG. 2K shows an example of a drawing of a “request group selfie” screen on a user device;

FIG. 2L shows an example of a drawing of a “verification” screen on a user device;

FIG. 3A shows an example of a flow chart of a method performed by an initiator/initiator to create a combined image using the initiator's image and a contributed image of at least one invitee;

FIG. 3B shows an example of a flow chart of a process to obtain an initiator's image;

FIG. 3C shows an example of a flow chart of a process to obtain at least one contributed image from at least one invitee;

FIG. 3D shows an example of a flow chart of a process to combine the initiator's and invitees' images into a combined image;

FIG. 3E shows an example of a flow chart of a process of selecting sub-images from the initiator's and invitees' images;

FIG. 3F shows an example of a flow chart of a process of arranging sub-images within a background image;

FIG. 3G shows an example of a flow chart of a process of blending arranged sub-images to blend into a background image;

FIG. 4A shows an example of a flow chart of a method performed by an invitee that is invited to contribute an image to create a combined image;

FIG. 4B shows an example of a flow chart of a process of selecting an image to be shared in order to create a combined image;

FIG. 5 shows a schematic diagram of an example of an image-combining apparatus;

FIG. 6 shows a schematic diagram of an example of a user equipment that can be used as an image-combining apparatus;

FIG. 7A shows a drawing of an example of a “configuration” screen to partition a real-time frame into two, three, four, five, or six partitions;

FIG. 7B shows a drawing of an example of a “four-users configuration” screen to partition a real-time frame into four partitions, each partition being enumerated as either a 1^{st} partition, a 2^{nd} partition, a 3^{rd} partition, or a 4^{th} partition;

FIG. 7C shows a drawing of an example of a “four-users configuration” screen wherein a respective user's sub-image is displayed in each corresponding partition;

FIG. 7D shows a drawing of an example of a “four-users configuration” screen, wherein an alternative four-user partitioning scheme has been selected

FIG. 8A shows a drawing of a “select contact” screen to select a contact for a group selfie, in which the user thumbnail, contact thumbnails, menu icons, and search text box are shown in solid lines, according to one implementation;

FIG. 8B shows a drawing of a “select contact” screen to select a contact for a group selfie, in which the user thumbnail, contact thumbnails, and take image icon are shown in solid lines, according to one implementation;

FIG. 8C shows a drawing of a “select contact” screen to select a contact for a group selfie, in which the user thumbnail and the contact thumbnails are shown in solid lines, according to one implementation;

FIG. 8D shows a drawing of a “select contact” screen to select a contact for a group selfie, in which the contact thumbnails are shown in solid lines, according to one implementation;

FIG. 9A shows a drawing of one implementation of a “select group-selfie” screen for selecting among multiple group selfies, in the “select group-selfie” screen the user thumbnail, the first and second group-selfie contributor thumbnails, the slide-bar toggle switch, the menu icons, and the comment icon are all shown in solid lines;

FIG. 9B shows a drawing of one implementation of a “select group-selfie” screen for selecting among multiple group selfies, in the “select group-selfie” screen the first and second group-selfie contributor are shown in solid lines;

FIG. 9C shows a drawing of one implementation of a “select group-selfie” screen for selecting among multiple group selfies, in the “select group-selfie” screen the first and second group-selfie contributor thumbnails and the slide-bar toggle switch are all shown in solid lines; and

FIG. 9D shows a drawing of one implementation of a “select group-selfie” screen for selecting among multiple group selfies, in the “select group-selfie” screen the first and second group-selfie contributors for three group selfies are shown in solid lines.

### DETAILED DESCRIPTION

As discussed above, conventional file-sharing technologies enable users to share the users' selfies and other images with friends and family, but these technologies do not enable separately located users to combine images creating group selfies and combined images. Improvements over conventional technologies enabling group selfies for distantly located users would create a feeling of comradery, collaboration, and togetherness among group-selfie collaborators, even though the collaborators are not physically located together within the viewing angle of a single camera frame (e.g., the camera can be a stand-alone digital camera or an integrated camera that is part of a smart phone or tablet computer). An improved technology would include the ability to share, view, and combine digital images over a network. For example, remotely located smartphone users may want to have a single digital image that combines selfies of each of the users—a combined image or group selfie. For example, facial recognition algorithms can select sub-images of a face from each image (e.g., a selfie) contributed by the respective collaborators and combine these sub-images of the users' faces into a single combined image (e.g., group selfie). The process of combining user contributed images into a combined imaged can also include resizing, filtering, and blending the sub-images to harmonize the sub-images with a base image to create a unitary harmonious image that includes the face of each respective collaborator.

In contrast to the improved group selfie technology, conventional methods only enable collocated users to acquire a group-selfie by gathering all of the users within the frame of a single digital camera. There is no conventional method to obtain a group selfie of remotely located users. Under conventional methods, remotely located users were consigned to sharing their individual selfies, rather than assembling a single group selfie by combining the individual selfies of their remotely located cohorts.

The present disclosure describes a method of using a social network for taking, combining, and sharing digital images among users who are not necessarily present at the same location. Further, the digital images can be annotated, edited, stored and shared using the social network.

In one embodiment, the disclosure relates to a group selfie including images of people that are not necessarily present at the same physical location. A computer implemented method is used to gather, process, and join selfies taken by individual group members connected by the social network (e.g., the group members may be friends or colleagues connected to each other using a social media).

In one embodiment, an initiating user creates a request to selected users of the social network platform. The request can also include a request for authorization to use the shared images, wherein the authorization request can include an authorization code, a permission check box, radio button, or push button signifying consent that the requesting user can use and share the provided digital images. In consenting to share the digital image, each user makes the shared image accessible to at least one other user (e.g., the requesting user) to use and modify the provided images.

In one embodiment, computer automated algorithms support a graphical user interface (GUI) in which the images are combined into a combined image. Sub-images from the individual users' images are arranged within a combined image using the user input provided in the GUI and using the automated algorithms.

In certain implementations, a “combined image” can be a single visually coherent image in which separate images are blended to appear as a single image. In another implementation, a “combined image” can include separate images that are tiled (e.g., separate juxtaposed images with a sharp demarcation at the respective boundaries between the separate images that contribute to the combined image). Herein, the example of the blended combined images is primarily discussed, but “combined image” is understood to include both blended combined images and sharp-boundary combined images. However, not all processing steps that are applicable to blended combined images will also be applicable to sharp-boundary combined images, as would be understood by one of ordinary skill in the art.

Once the individual images have has been assembled into a combined image the group selfie can be posted, shared, printed, or used for other activities. In one embodiment, permissions from the participants are acquired before the group selfie can be posted, shared, printed, or used for other activities.

In one embodiment, a real-time group selfie will be created, when individual images provided by each of the users in a selected user group are transmitted in real time and the group selfie is updated in real time. Each user is assigned a predetermined partition of the frame of the combined image, and sub-images corresponding to the respective users are displayed within their respectively assigned partitions. Thus, the group-selfie frame displays, as a combined image, sub-images from each member of the user group according to their assignments of predetermined partitions. A user can then capture and store an image of the combined real-time image by, e.g., selecting an “image capture” button. In this embodiment, because the sub-images are being continuously updated, the combined image represents each of the users at the same instance of time. The real-time simultaneity of the group selfie further enhances the feeling of togetherness and comradery created by the group activity of creating a combined image or group selfie.

The digital cameras used to acquire digital images are not limited and include digital cameras corresponding to smart phones, tablet computers, web cams, stand-alone cameras, and wireless user equipment. Digital images can also be acquired using any digital camera including, e.g., a DSLR camera, a CCD camera, a CMOS camera, or Google Glass™ Further, digital images can also be acquired using any existing, emerging, or future technologies that are capable of capturing digital images, such as eye glasses, drone captured pictures, or any other means of capturing a photograph or digital image. Additionally, the digital images can be stored using any known on-device memory or external memory, including, e.g., cloud storage or file sharing databases.

In one implementation, the inventive method can include procuring, integrating, and sharing combined digital images, such as group selfies or self-portraits, wherein the combined image is obtained using a stitched image method. Further, the method can include that the individual images that are stitched together to create the combined image are obtained using social media by providing a list of friends with whom the initiating user can interact via social media. The users can be matched from a contact list, social network APIs, and/or invited by email or text message to join a social network platform. The initiating user who decides to take a group selfie can select and invite contacts from his “friends/contacts” list to take a group selfie, for example. After selecting a user from the “friends/contacts” list and sending the group-selfie request, an invitation is sent to the selected users who are then poked to accept the group-selfie invitation. Once the selected users accept the invitation, the cameras of the selected users will be activated and they can select from previously taken images or take a new image within a certain time window. The cumulative contributed images from the selected users can be collected at the users' devices, or at a server, and a combined image can be created using the individual images of the selected users. In one implementation, a real-time combined image can be obtained when the images from the cameras of the selected users are sent over the network in real time to create a real-time combined image. The combined image can then be used for editing, annotating, and/or collage making. Additionally, combined-image products derived from the combined images can consequently be stored, or shared through social network. Note that this system could be implemented as a standalone application, or as an add-on to currently implemented systems like Facebook®, GooglePlus®, Twitter®, etc. Notifications of the shared combined images can be pushed to the contributors and to their social network “friends” by posting a notification onto newsfeed by using newsfeed screen or notifications screen, for example. Also, a user's combined images can be displayed using a timeline to organize and present the combined images to be accessed and viewed.

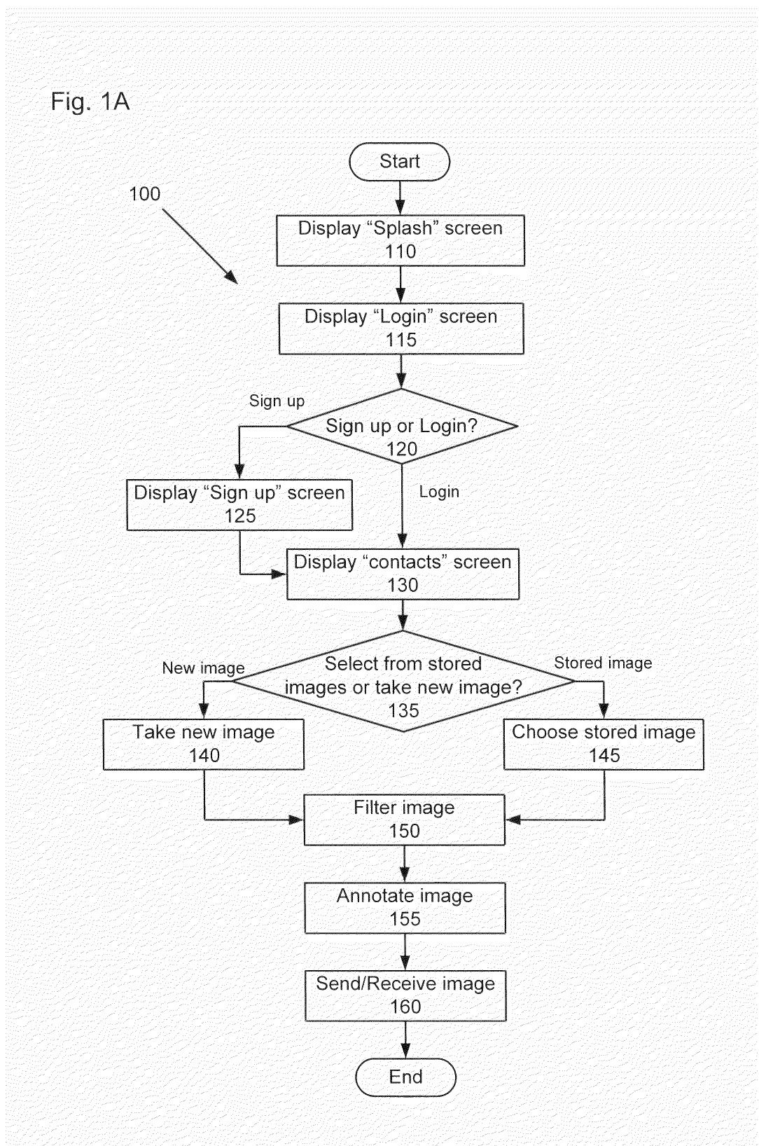

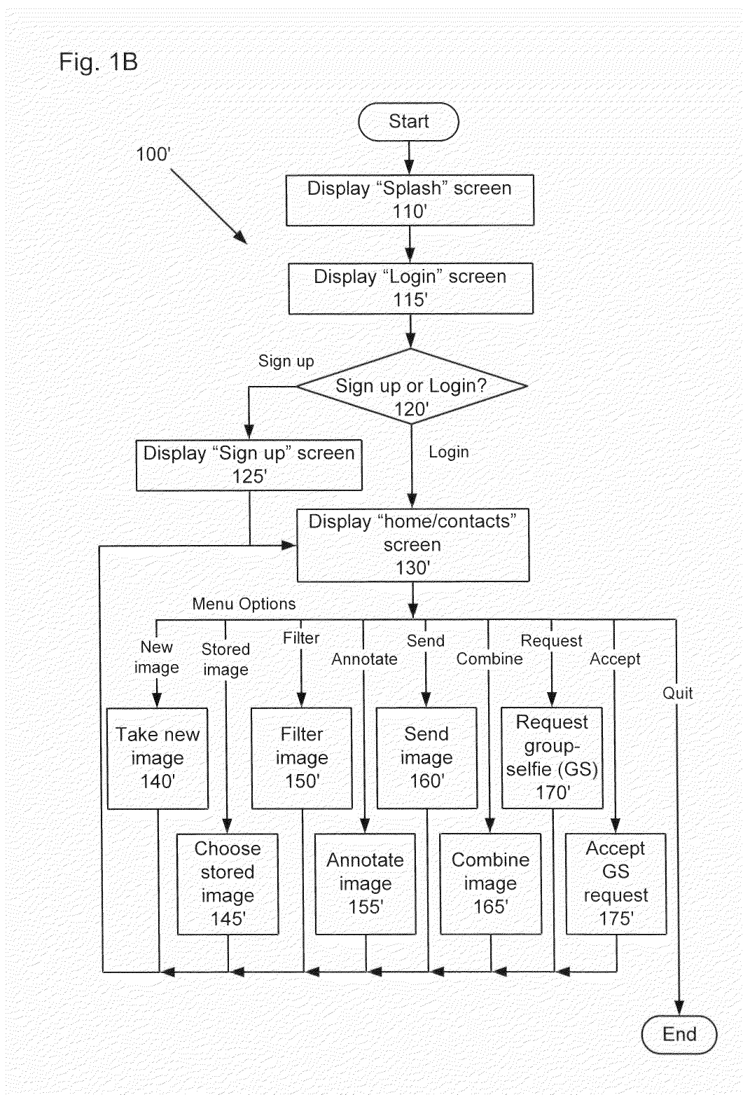

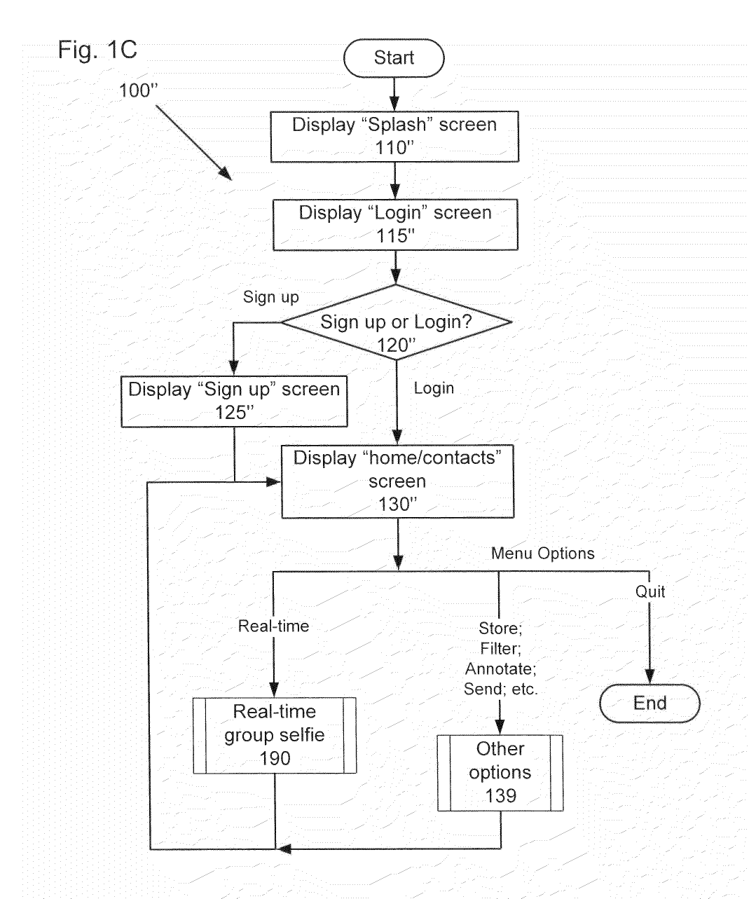

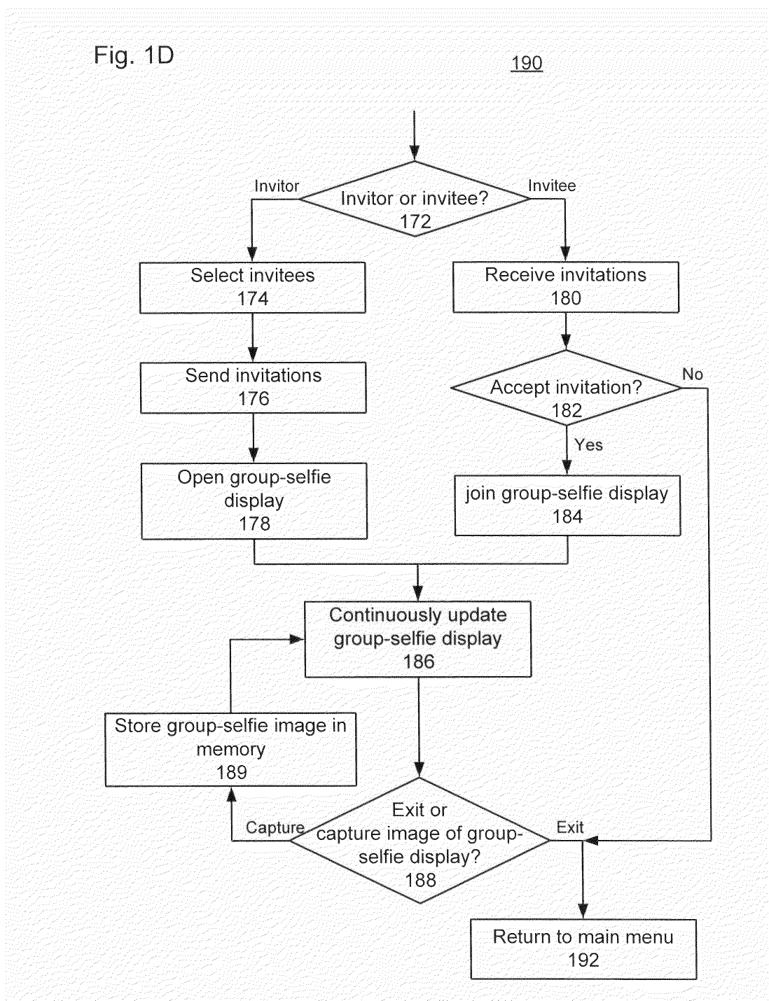

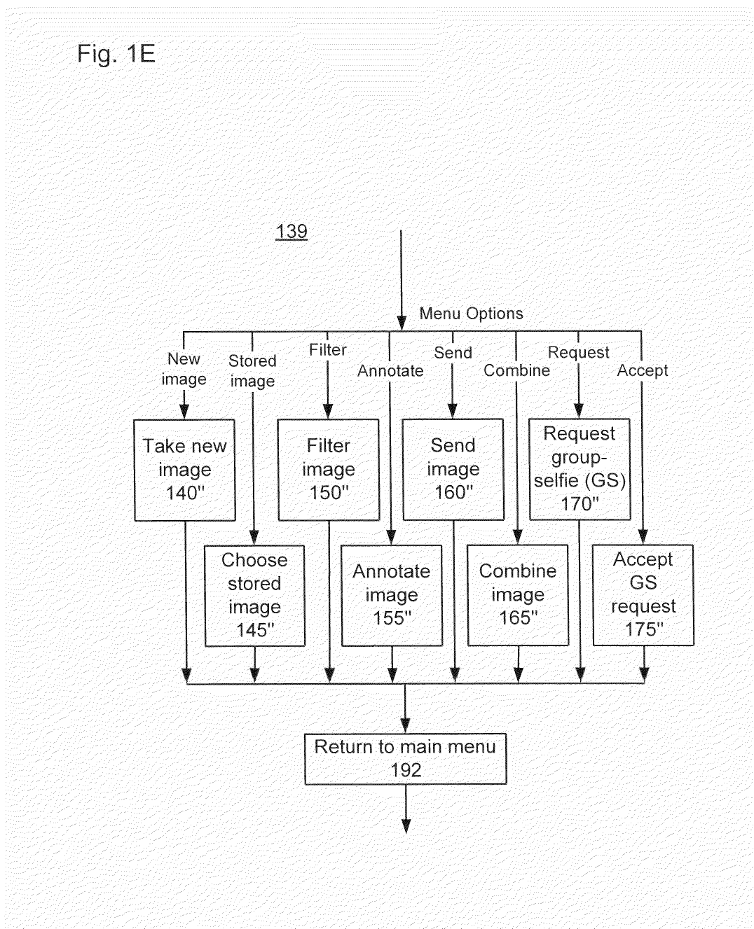

Referring now to the drawings, wherein like reference numerals designate identical or corresponding parts throughout the several views, FIG. 1A shows a flow diagram of a method 100 of obtaining a group digital image by combining images contributed by a plurality of user connected on a network. For example, the users can be smartphone users connected via a wireless network. Further, the users can each have an app on their respective smartphone that enables them to share digital images, for example. In one implementation, the digital images can be stored using cloud computing and cloud data storage. The users can then selectively share or otherwise make their individual digital images available for selected other users to view and interact with. For example, photo-sharing websites such as Instagram®, Snapfish®, Flickr®, Photobucket®, and Pinterest® currently enable interne users to share photos. As discussed herein, the photo sharing of conventional websites, storage services, and apps can be extended to include merging individual images/photos to create a combined image.

In addition to smartphone users, the networked user devices can include desk-top computers, tablet computers, camera phones, smartphones, wearable technology (e.g., Google Glass®), and other devices capable of obtaining digital images and having an interface that can be connected to a network. The network can be a public network, such as the internet, or a private network, such as a LAN, a VPN, a Wireless LAN, or a WAN.

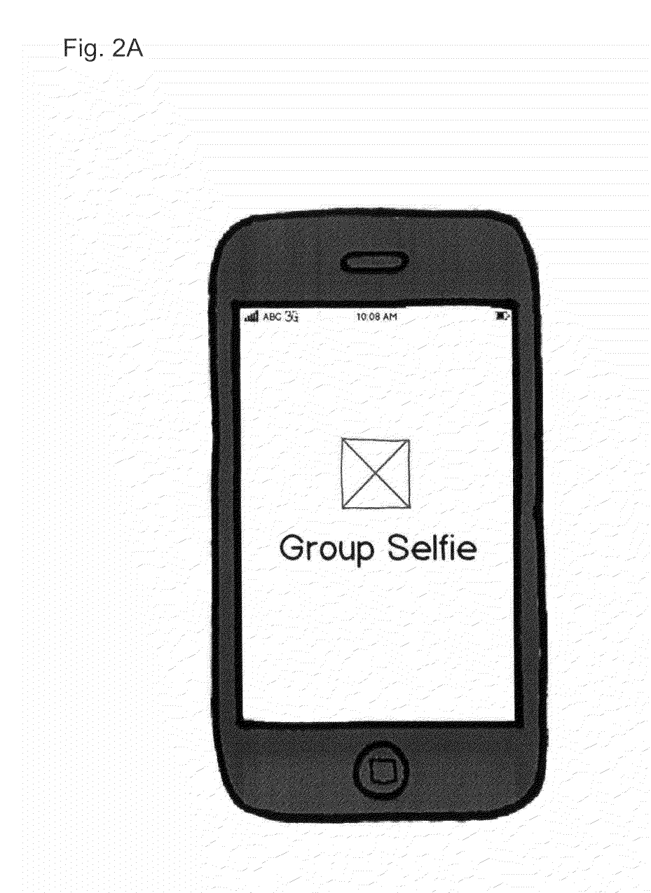

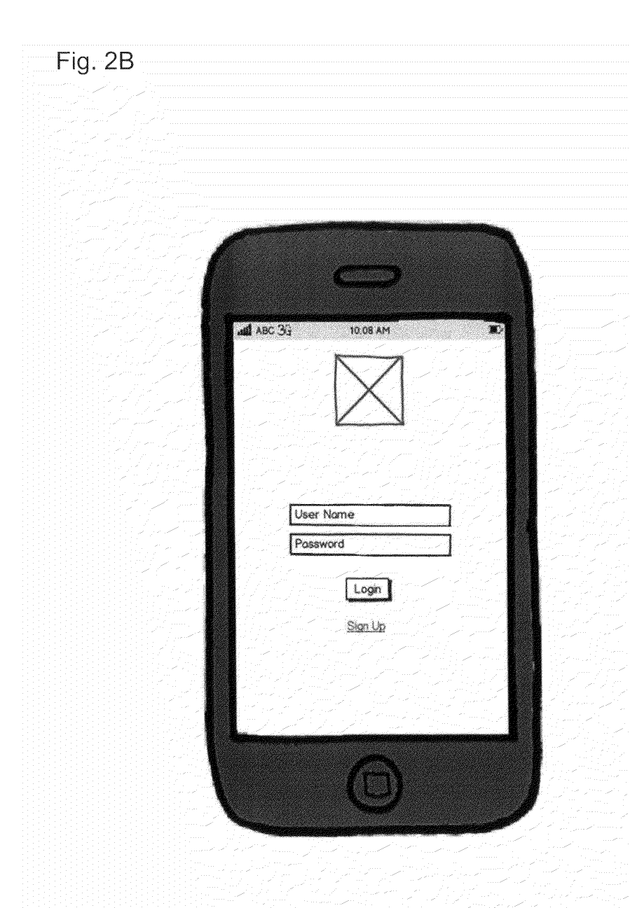

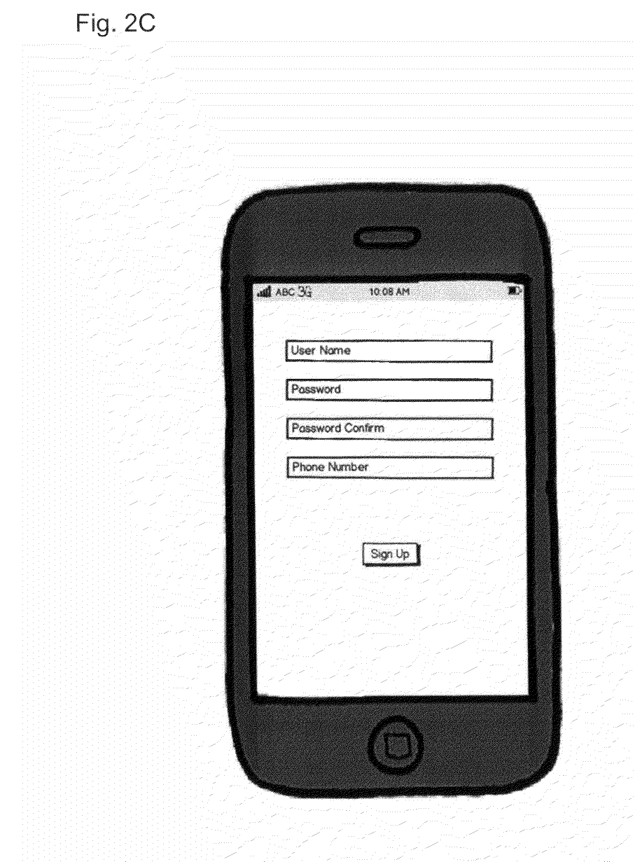

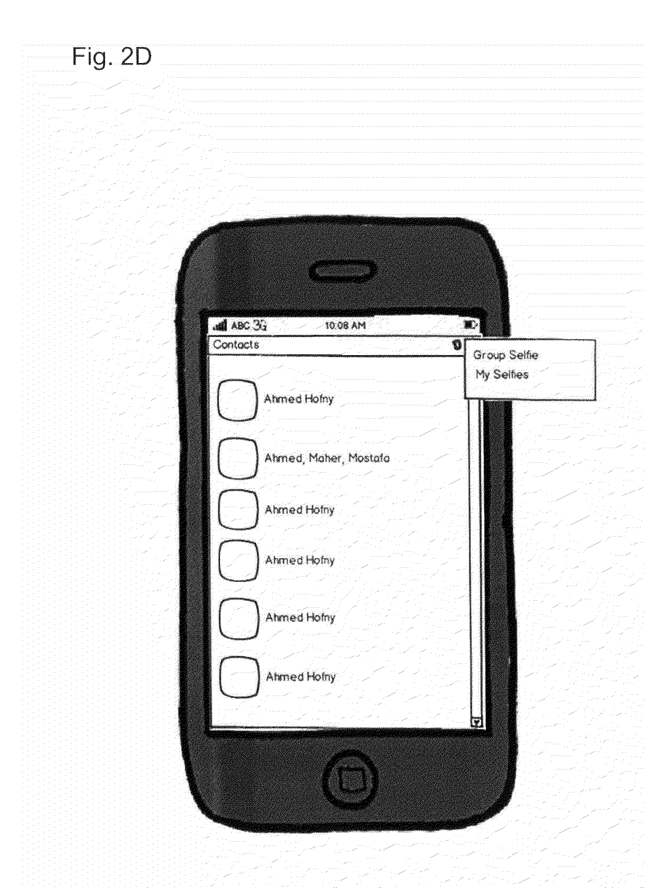

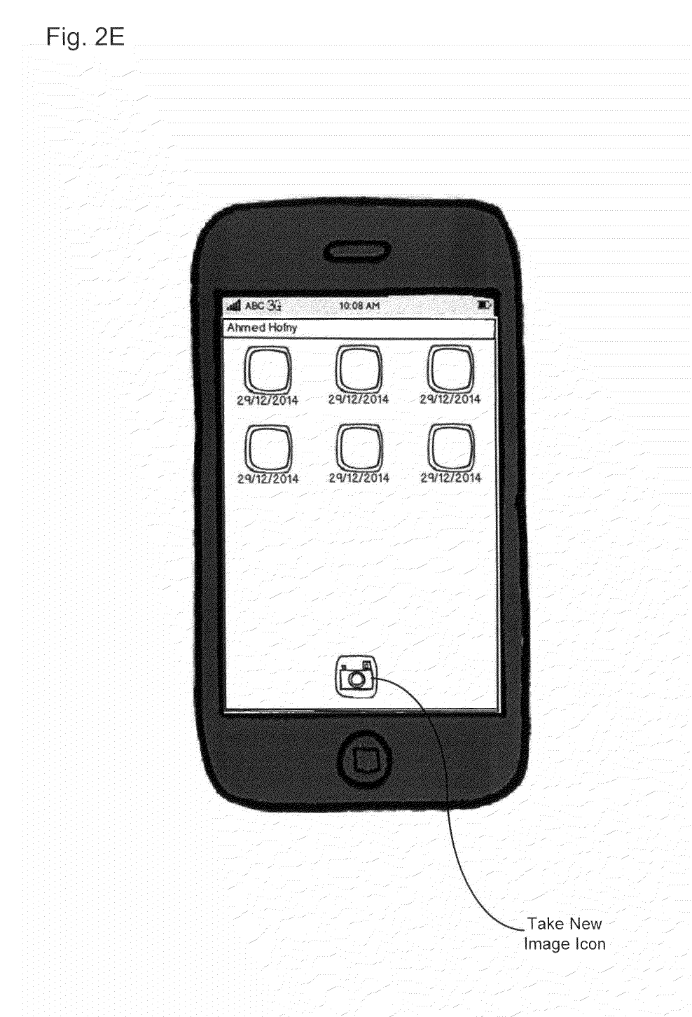

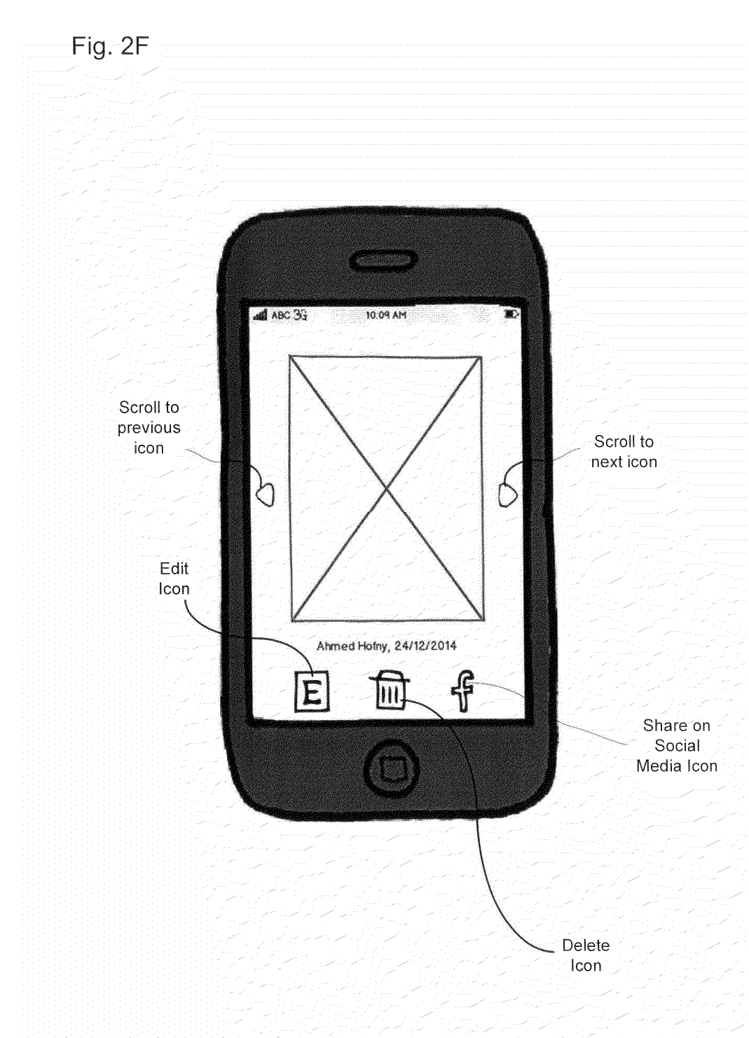

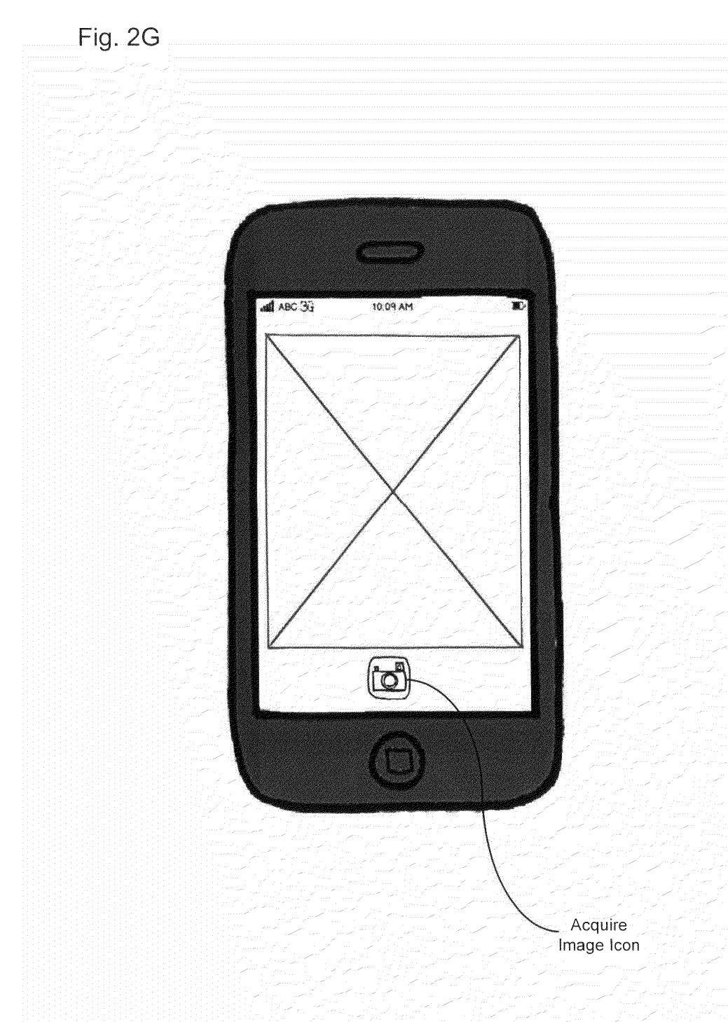

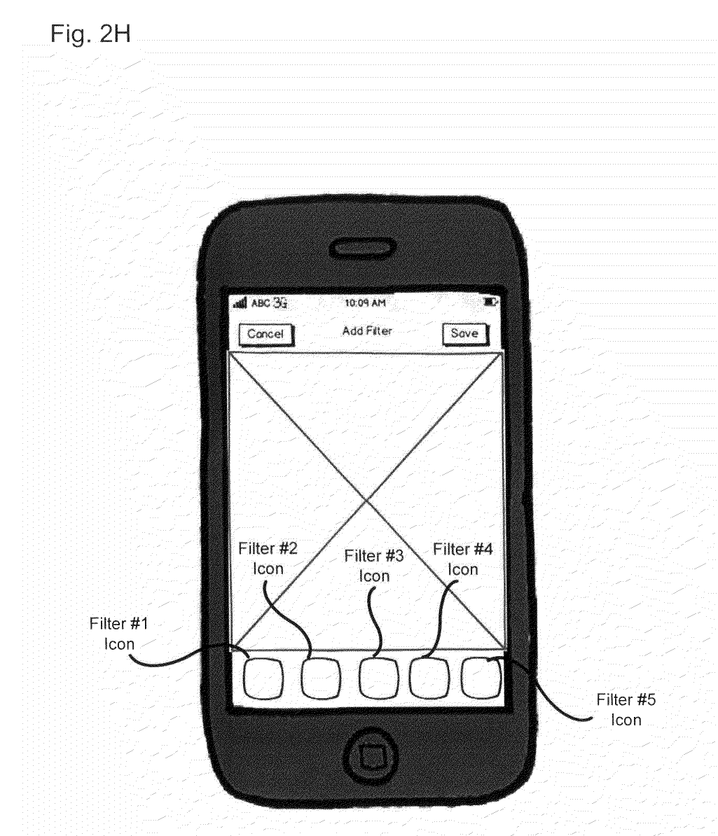

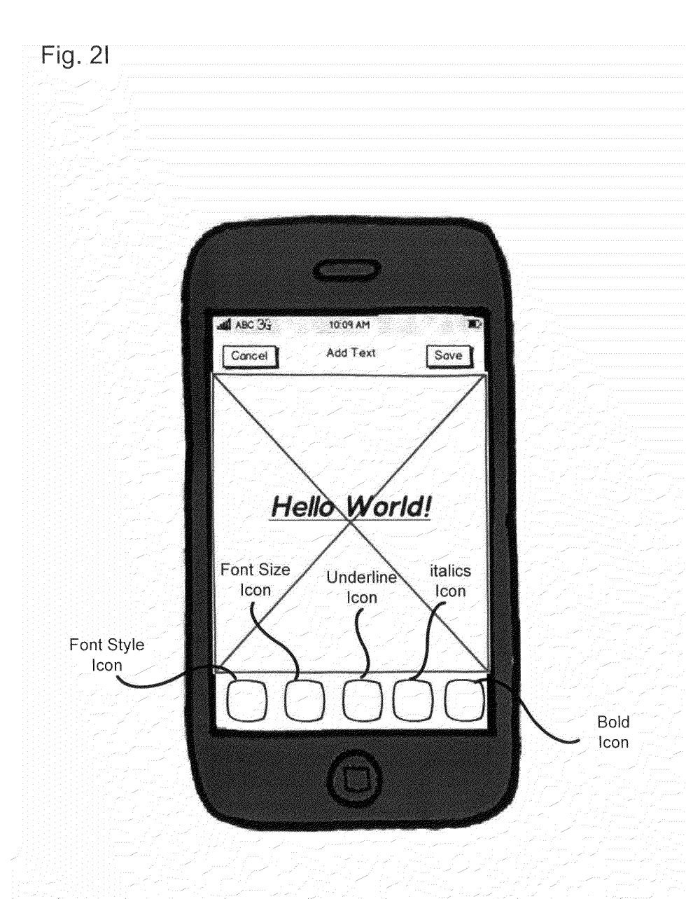

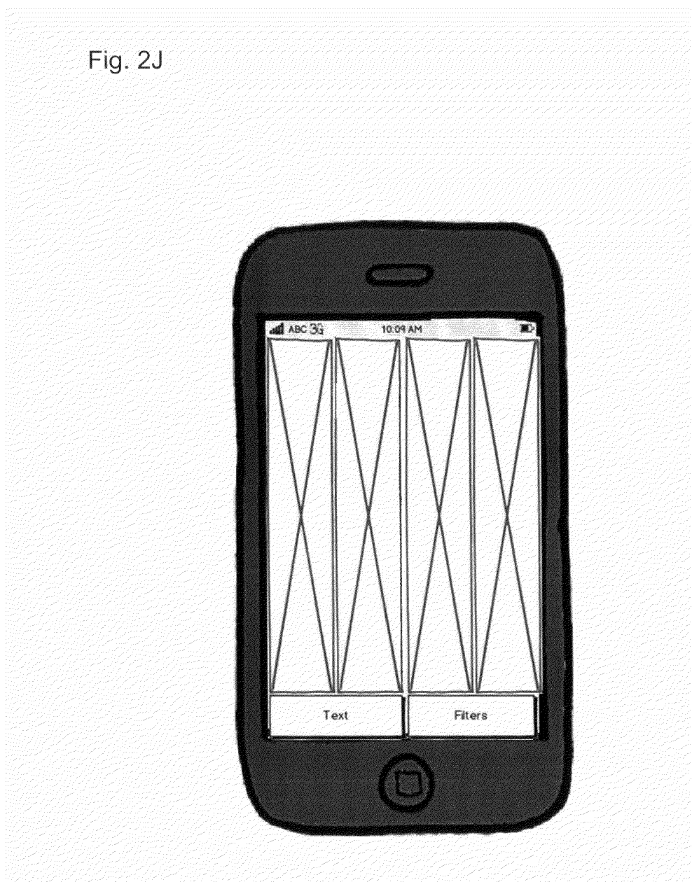

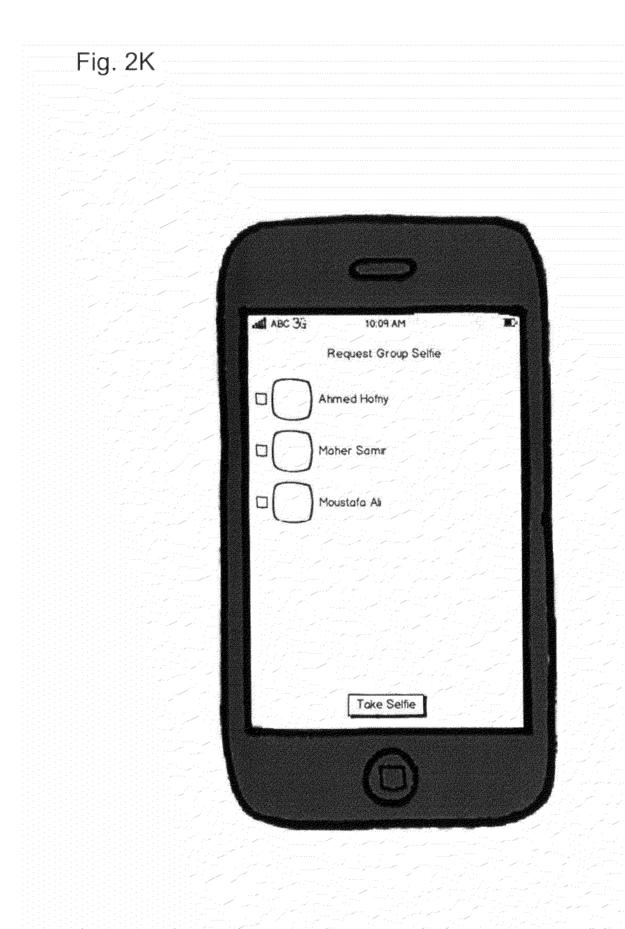

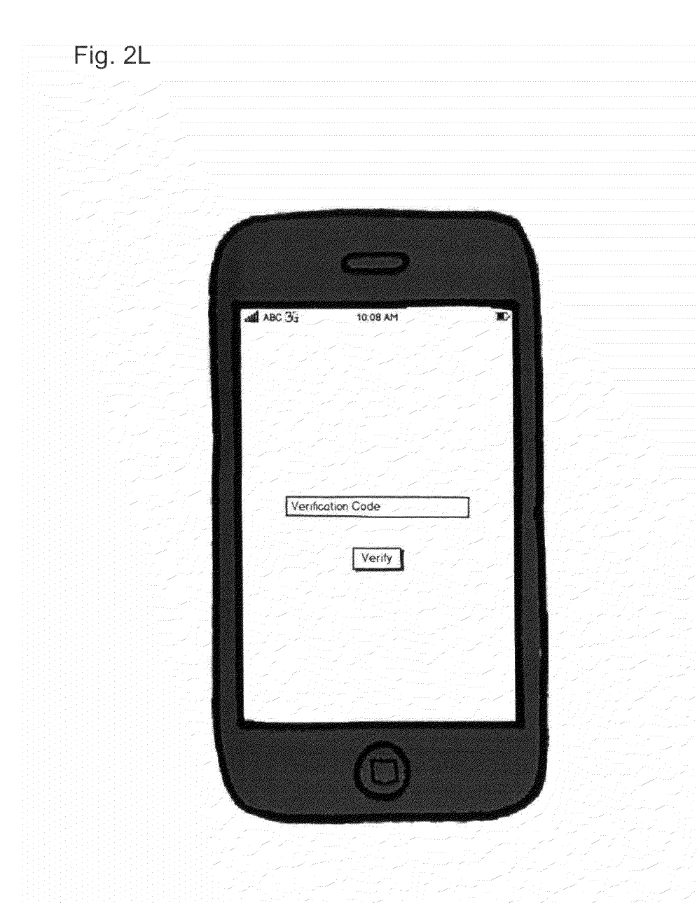

In step 110 of method 100, an image-combining program is initiated by displaying a “splash” screen, such as the splash screen shown in FIG. 2A. The splash screen and all other screens described herein can be displayed, for example, on a smartphone, a tablet computer, a laptop computer, a conventional desk-top computer screen, or other graphical interface accessible to a user. Step 110 is optional and can be omitted is some implementations of method 100.

Next in step 115 of method 100, a “login” screen is displayed, as shown in FIG. 2B, and the user has an option to “login” on the social network platform (e.g., for repeat users), or has an option to “sign up” on the social network platform (e.g., for first-time users or users setting up a second/additional account). If a user enters a user name and password and then presses the “login” button, then the user name and password will be validated against a lookup table of authorized users. If the user name and password are authorized, then, at step 120, method 100 will proceed to step 130. If the user selects “sign up” rather than “login,” then, at step 120, method 100 will proceed to step 125.

At step 125 of method 100, a “sign up” screen is displayed, as shown in FIG. 2C. In on implementation of the “sign up” screen, the user can enter a user name, a password, confirm the password, and enter a phone number. In one implementation, entering the phone number is optional. Next, the user selects the “sign up” button, and the username is checked against a lookup table of usernames to check the availability of the user name entered by the user. If the user name is available, then the user name is registered and entered into a lookup table together with the password and phone number entered by the user. Additionally, the password is compared with the password confirmation that is entered, and if they do not match the user is asked to reenter the password and the password confirmation before leaving the “sign up” screen. After completing the signup process, method 100 proceeds from step 125 to step 130.

Next at step 130 of method 100, a “contacts” screen is displayed, as shown in FIG. 2D. From the “contacts” screen a user can, for example, select other users from a list of contacts to enter and/or change the contact information, such as phone number and email address, of the respective existing or new contacts. In one implementation, selecting a button in the menu ribbon at the top of the “contacts” screen results in the appearance of a drop down menu enabling the user to select between either “My Selfie” or “Group Selfie.” Selecting “My Selfie” enables the user to view their digital images without initiating a group-selfie request. In contrast, selecting “Group Selfie” initiates requests to a selected group of contacts requesting digital images to create a combined image. By selecting group selfie a “request group selfie” screen is displayed, such as in FIG. 2K, providing the user with a list of users and corresponding check boxes to select users that will receive a group-selfie invitation. Next, the user sends the group-selfie invitation by, e.g., selecting the “take selfie” button shown in FIG. 2K. Next, the user's “stored images” screen is displayed, as shown in FIG. 2E, after sending the group-selfie invitation to the selected users.

In one implementation, the “request group selfie” screen will include an indication of which of the potential requestees is currently online and active. This indication of which users are active can aid the requestor to select those users that are most likely to be responsive to the request. In one implementation, a requestee must accept the group-selfie request/invitation within a predefined time window or else the request will expire. Additionally, in another implementation, the request will expire if the requestee does not both accept the request and also contribute the requested image within a predefined window.

If the “My Selfie” menu item was selected rather than the “Group Selfie” menu item in FIG. 2D, then step 130 of method 100 proceeds directly from displaying FIG. 2D to displaying FIG. 2E. On the other hand, if the “Group Selfie” menu item was selected in FIG. 2D then, FIG. 2K is displayed before displaying FIG. 2E.

In one implementation, after a user has selected between “My Selfie” and “Group Selfie,” the user has a choice, as shown in FIG. 2E, of either selecting a stored image or acquiring a new image. This choice is reflected by the inquiry at step 135 of method 100. If the user has previously selected “Group Selfie” in the “contact” screen of FIG. 2D, then the user can either select a stored image or take a new image to be used in the group selfie together in combination with the images received from the selected users from the “contacts” screen. If the user has previously selected “My Selfie” in the “contact” screen, then the user can either select a stored image or take a new image to view and/or share with the selected users from the “contacts” screen. If the user chooses “new image,” then, at inquiry step 135, method 100 proceeds to step 140. If the user chose “stored image,” then, at inquiry step 135, method 100 proceeds to step 145.

At step 135 of method 100, a “stored images” screen is displayed, as shown in FIG. 2E. The “stored images” screen shows icons corresponding to stored digital images. The stored digital images can be stored on the user's device or can be stored remotely using, e.g., cloud storage or a remote data-management service. The icons can be tiled as shown in FIG. 2E, or the icons can be organized as an ordered list. Any known method of arranging and displaying the icons can be used. In certain implementations, each icon of a stored image can also include a label, such as the date that the image was taken as shown in FIG. 2E. Additionally, in certain implementations, the icon corresponding to each stored image can be a thumbnail image of the stored image. A user can select the icon corresponding to a stored image for viewing and/or sharing. In one implementation, selecting a stored image icon will cause a drop down menu to appear displaying a choices of actions, such as sharing the image, viewing the image, editing the image, annotating the image, deleing the image, etc. In certain implementations, the “stored images” screen can also include a “take an image” icon that enables users to take a new image by, e.g., going from step 145 to step 140 of method 100. In one implementation, the choice between acquiring a new image by selecting the “take an image” icon or selecting the stored imaged provides the choice indicated by step 135 in method 100, wherein the user chooses between selecting a stored image or acquiring a new image.

In one implementation, when an image icon is selected and a user chooses to view the stored image, a “view image” screen is displayed, as shown in FIG. 2F. The “view image” screen displays the selected image, and the “view image” screen can also enable a user to scroll to the previous or next image, share the image on social media such as Facebook®, delete the image, or edit the image, for example, by selecting an icon corresponding to each of these options. FIG. 2F shows examples of icons for editing, deleting, sharing on social media, scrolling to next image, and scrolling to previous image. Additionally, the “view image” screen can include functionality of returning to the “stored images” screen and taking a new digital image before proceeding to step 150.

At step 145 of method 100, an “acquire image” screen is displayed, as shown in FIG. 2G. In one implementation, the “acquire image” screen displays the frame currently detected by a sensor of the digital camera. The user can store into memory the image detected by the sensor by, e.g., selecting an “acquire image” icon. In one implementation, after the “acquire image” icon has been selected the acquired image will be displayed using the “view image” screen of FIG. 2F. In one implementation, after the “acquire image” icon has been selected the “acquire image” screen continues to be displayed, enabling the user to continue acquiring digital images until the user selects an icon or button that enables the user to go to another screen. In one implementation, after the “acquire image” icon has been selected the “stored images” screen of FIG. 2E is displayed with the recently acquired image. In one implementation, when the user is in any of the “contracts” screen, the “acquire image” screen, the “view image” screen, and the “stored images,” the users can choose to proceed to “contracts” screen, “acquire image” screen, the “view image” screen, or the “stored images” screen by scrolling over a menu bar to enable a drop down menu providing the user with the options of selecting one of these screens. Additionally, in one implementation, the drop down menu can include a choice to select among a “filter image” screen, an “annotate image” screen, and a “send image” screen.

In one implementation, as shown in FIG. 1A, the method 100 proceeds to the step 150 after step 140 and also after step 145. In step 150, a “filter image” screen is displayed, as shown in FIG. 2H. In one implementation, the filter screen is optional. The “filter” screen enables a user to modify the image according to a predefined image processing method. Any known image-processing filter can be used, including: a soft-image filter, a blurring image filter, an edge enhancing filter, a sharpening image filter, a color filter, a black and white filter, a color balance filter, a brightness filter, a contrast filter, hue and saturation adjustments, predefined named filters (e.g., the Instagram® filters Perpetua, Aden, Ludwig, Sepia, Amaro, Brannan, Earlybird, Hefe, Hudson, Inkwell, Kelvin, Lo-fi, Mayfair, Nashville, Rise, Sierra, Sutro, Toaster, Valencia, Walden, Willow, X-Pro II, Slumber, Cream), grey scale filters, olde-tyme filters to fade the image giving it a nostalgic feel, warm color filters, out-door color filters, Sepia tone filters, etc. In one implementation, the digital image can also be distorted, stretched, or elongated according to input by the user.

Next, the method 100 proceeds from step 150 to step 155, wherein an “annotate image” screen is displayed, as shown in FIG. 2I. In the “annotate image” screen, text can be added to the image to provide explanations and to preserve memories associated with the image. This text can be anchored to or associated with particular points within the image (e.g., an image of multiple people can have the name of each person linked to the part of the image corresponding to the named person), or this text can be associated with the entire image. Further, in one implementation, the font style, font size, italics, bold, etc. can be adjusted according to input by a user. In one implementation, the steps of annotating and filtering are optional. Further, in one implementation, the steps of annotating and filtering can be selected from a drop down menu.

Next, the method 100 proceeds from step 155 to step 160, wherein the filtered and annotated image are made available for creating a group selfie in accordance with the initiating user's group-selfie request. For example, the contributed images can be received by the initiating user.

Alternative implementations of method 100 can be performed depending on whether the user performing method 100 is an initiator of a group-selfie request (i.e., the initiator) or the recipient of a group-selfie request initiated by another (i.e., an invitee). If the user performing method 100 is an invitee rather than an initiator, then step 130 will include receiving a group-selfie request rather than sending a a group-selfie request. In one implementation, the invitee is poked with the request, and then chooses to either accept or deny the request. If the request is denied then the user will not send the requested image; but if the group selfie request/invitation is accepted then the user will proceed through steps 135 through 155 to select and prepare the requested image before sending the image according to the request of the initiating user. In one implementation, the invitation to participate in the group selfie will include an authorization/verification code to join the group selfie. If an authorization/verification code is required, then step 130 can also include entering the authorization/verification code into a “verification” screen, such as the screen displayed in FIG. 2L.

If the user is also an initiating user (i.e., initiator), then, in one implementation, the initiator receives contributed images from invitees in step 160, after which the initiator performs steps of preparing the contributed images and combining them to create a combined digital image. In one implementation, the contributed images are stitched together and combined to create the combined image, wherein the combined image includes a sub-image from each contributed image. FIG. 2J shows an example of an “image combination” screen, wherein a plurality of contributed images are shown side-by-side on the screen. In one implementation, the initiating user selects a contributed image from each contributor, and selects a sub-image from each selected image. These sub-images are then combined into a primary image. The primary image can be selected from all of the contributed images, for example. Further, a facial recognition algorithm can be used to identify faces, and an image processing algorithm can be used to determine a boundary around each of the faces. Furthermore, if there is more than one face in a contributed image, the initiating user can select which of the faces will be included in the sub-image. Additionally, the initiating user can also adjust the boundaries of the sub-images in order to optimize the sub-images.

In one implementation, the contributed images not selected as the primary image (also referred to as the base image or background image) can be designated as secondary images. The initiating user can position the sub-images from the secondary images within the primary image to create the combined image. Alternatively, an automated algorithm can position the sub-images within the combined image to minimize overlap among the sub-images. In one implementation, an automated algorithm can assist the initiating user in selecting the sub-images from the primary and secondary images. Further, another algorithm can assist the initiating user to arrange the selected parts within the primary image to create a combined image. For example, the automated algorithm can arrange the selected parts from the contributed images to minimize the overlap among the sub-images. In one implementation, the initiating user can also adjust the size, contrast, colors, sharpness, shading, and other aspects of the selected parts in order to harmonize the sub-images to the primary image and to improve the match for the color, dark level, and contrast between the sub-images and the primary image.

Additionally, another automated algorithm can assist the user in manually matching the color, dark level, and contrast of the sub-images and the primary image. For example, an average color, contrast, and dark level of each sub-image can be calculated and then adjusted to match to the average color, contrast, and dark level of the region of the primary image in which the respective sub-image will be positioned. Alternatively, an average color of each selected part can be matched to correspond to an average color of the entire primary image.

Also, the borders between the primary image and the sub-images can be blended by, e.g., blurring the images at the borders or tapering the transparency of the sub-images at the borders. In one implementation, user input can be used to determine the width of this blending region around the sub-images, and input from a user can also be used to determine the type of blending between the sub-images and the primary image.

After the sub-images have been selected from the contributed images, arranged within the primary image, and blended with the primary image, the combined image is finished and is prepared for conventional use as an image. For example, the initiating user can store the combined image in a computer readable memory, share the image with the selected users or other users, print the combined image, etc.

FIG. 1B shows another method 100′ of creating a combined selfie. For example, step 110′ displaying a “splash” screen, step 115′ displaying a “login” screen, step 120′ inquiring whether to sign up or login, and step 125′ displaying the “sign up” screen can each be performed in the same manner as the respective steps 110 through 125 of method 100 discussed with respect to FIG. 1A. In method 100′, after performing steps 110′ through 125′, each of the steps 140′ through 175′ can be initiated from a “home/contacts” screen. Further, the “home/contacts” screen is returned to after completing any of the steps 140′ through 175′.

For example, each of steps 140′ through 175′ can be initiated by selecting a corresponding menu option from a drop down menu. If the “new image” menu option is selected, then step 140′ will be initiated by displaying a “new image” screen similar to the screen shown in FIG. 2G and performing steps similar to those discussed for step 140 of method 100. If the “stored image” menu option is selected, then step 145′ will be initiated by displaying a “stored image” screen similar to the screen shown in FIG. 2E and performing steps similar to those discussed for step 145 of method 100. In one implementation, after displaying the screen of FIG. 2G and FIG. 2E respectively step 140′ and 145′ both proceed to display a “display image” screen similar to that shown in FIG. 2F. Additionally, the “display image” screen could be displayed in response to selecting a “display image” menu option.

If the “filter” menu option is selected, then step 150′ will be initiated by displaying a “filter image” screen similar to the screen shown in FIG. 2H and performing steps similar to those discussed for step 150 of method 100. If the “annotate” menu option is selected, then step 155′ will be initiated by displaying an “annotate image” screen similar to the screen shown in FIG. 2H and performing steps similar to those discussed for step 155 of method 100. In one implementation, the “filter” and “annotate” menu functions can be performed on individual images, on combined images, or on sub-images.

If the “request” menu option is selected, then step 170′ will be initiated by displaying a “request group selfie” screen similar to the screen shown in FIG. 2K and performing steps of selecting users from a list of users and sending a group selfie invitation/request performed in a similar manner to those corresponding requesting steps discussed with reference to step 130 of method 100.

If the “accept” menu option is selected, then step 175′ will be initiated to transmit a request to the selected other users to contribute to a combined image. In one implementation, a verification screen similar to FIG. 2L can be displayed for the selected users to provide a verification code. The selected users will then either accept or deny the group selfie request; or in one implementation if a selected user does nothing within a predefined time window then they will be time barred from contributing an image as though they had elected to deny the request. If the selected user denies the request, then they will not contribute an image. If the selected user accepts the request then they will be prompted to contribute an image. For example, the invitees can contribute a new image or a stored image; further they can filter and annotate the contributed imaged before sending the image. Finally, after selecting the contributed image and optionally editing the image by filtering and annotating, the selected users will send the image using a step similar or identical to step 160 of method 100.

If the “send” menu option is selected, then step 160′ will be initiated to transmit an image to another user. The send step 160′ can be used to send individual and combined images to other users, and the send step 160′ can be used to send a contributed image in response to a group-selfie request. In one implementation, the send step 160′ can be performed in a similar manner to the send step described in reference to step 160 of method 100.

If the “combine” menu option is selected, then step 165′ will be initiated by, e.g., displaying a “combine image” screen, such as the screen shown in FIG. 2J. In one implementation, the combine-images step 165′ can be performed in a similar manner to the combine-images process described in reference to step 160 of method 100.

FIG. 1C shows a method 100″ for creating a real-time group selfie. Step 110″ displaying a “splash” screen, step 115″ displaying a “login” screen, step 120″ inquiring whether to sign up or login, and step 125″ displaying the “sign up” screen can each be performed in the same manner as the respective steps 110′ through 125′ of method 100′ discussed with respect to FIG. 1B.

Step 130″ of method 100″ is similar to step 130′ of method 100′, in that a “home” screen is displayed and the “home” screen includes menu options to access various processes associated with taking, sharing, combining, and editing digital images. For example, in one implementation step 130″ of method 100″ is initiated by displaying a “home/contacts” screen, such as the screen shown in FIG. 2D. A user can select from menu options, such as those provided in a drop down menu, in order to initiate either a “real-time group selfie” process 190 or an “other options” process 139. After completing the “real-time group selfie” process 190 or the “other options” process 139 method 100″ returns to step 130″. The method 100″ ends when the menu option “quit” is selected.

FIG. 1D shows a method of performing the “real-time group selfie” process 190. The process 190 begins, at step 172, with an inquiry whether the user of the device performing the method 100″ is the initiating user (i.e., the invitor), or is a user receiving an invitation/request to collaborate in a group selfie (i.e., the invitee).

If the user is the invitor, then process 190 proceeds to step 174, wherein invitees are selected from a screen displaying a list, such as the screen shown in FIG. 2K. Next, at step 176, the invitations/requests to collaborate in a group selfie are sent. These invitations can be sent via text message, email, instant message, or cause an application to run on the invitee's smart phone, for example.

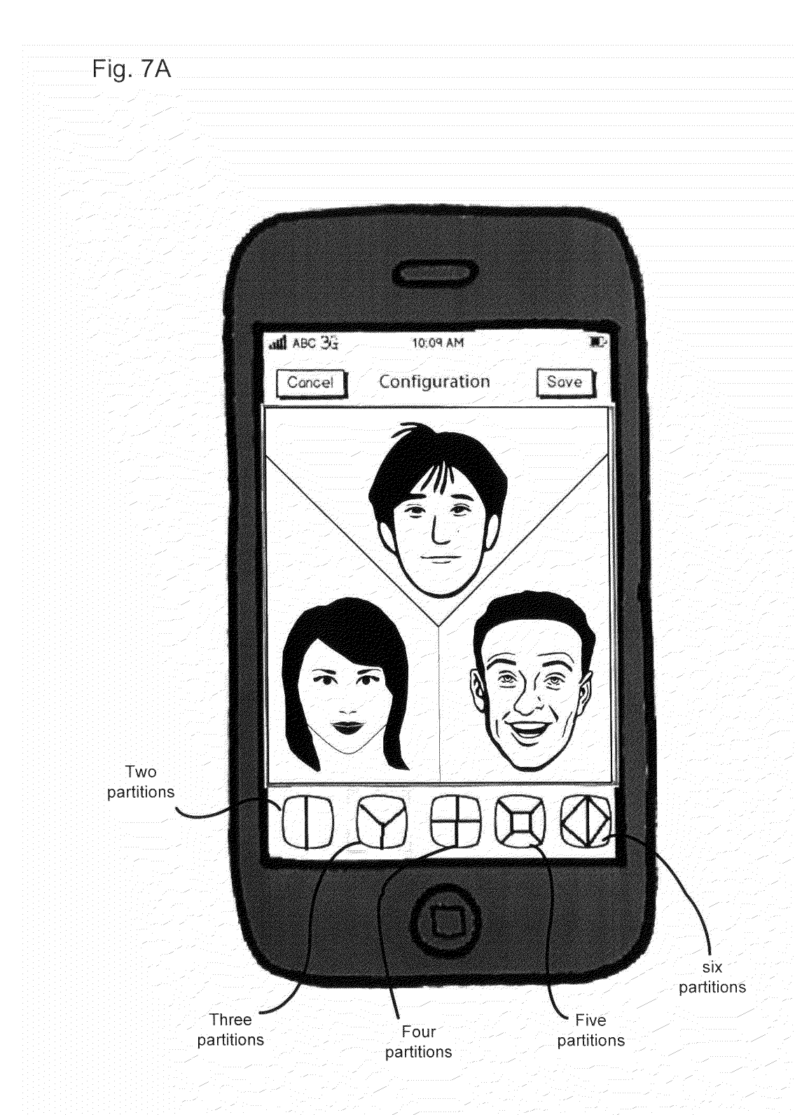

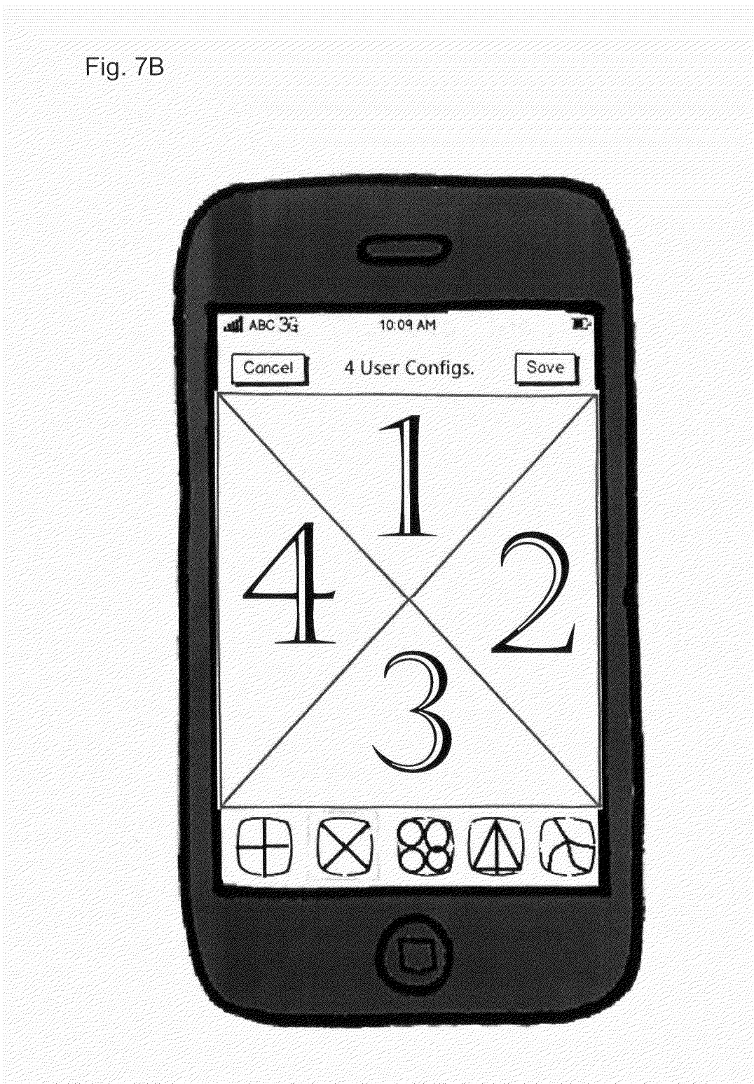

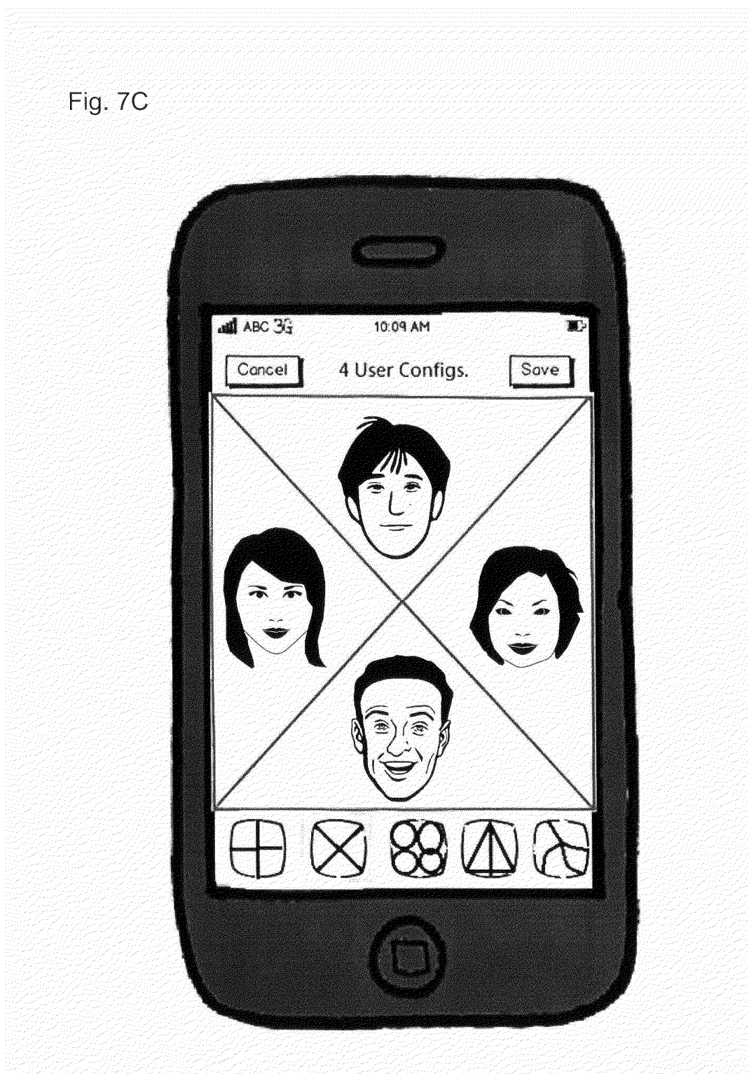

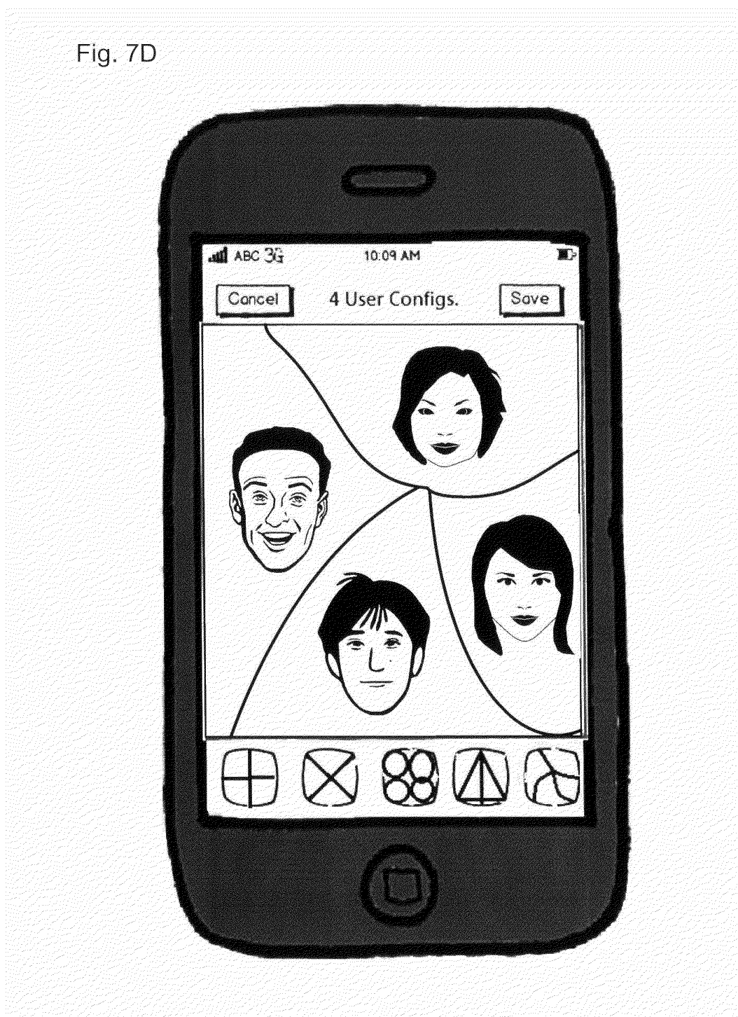

Next, at step 178 of process 190, a group-selfie screen is displayed. For example, the group-selfie screen can be the “Configuration” screen shown in FIG. 7A. The group-selfie screen includes partitions dividing the screen into a number of partitions equal to the number of collaborators in the group selfie. FIG. 7A shows three collaborators (i.e., the collaborators are represented by the faces in the combined image) and three partitions. Along the bottom are icons for selecting two, three, four, five, or six partitions.

In one implementation, a user selects the number of partitions, and alternatively, the number of partitions is automatically updated according to the number of collaborators joining the group selfie. The number of collaborators can change when a new collaborator joins the group-selfie collaboration either by initiating the group-selfie request or by accepting the request to collaborate in the group-selfie collaboration. Also, the number of collaborators can change when a collaborator exits the group-selfie collaboration. As shown in FIG. 7B each partition can be assigned a number and the collaborators can be assigned to the corresponding enumerated partitions in the order that they join the collaboration or by some other predefined criteria. Also, the collaborators can be reassigned among the partitions according to input from one of the collaborators. FIG. 7C shows a sub-image, corresponding to the respective face of each collaborator, displayed in each partition of a four collaborator partition using a diagonal grid arrangement for the partitions. Further, the icons displayed along the bottom of the screen in FIG. 7C show that the diagonal grid arrangement is selected from among several icons corresponding to alternative arrangements, including: a vertical grid, a diagonal grid, a close-packed circle arrangement, a common-vertex triangle arrangement, and a user-defined arrangement. FIG. 7D shows the sub-images partitioned according to the user-defined arrangement of partitions.

Sub-images are selected from the contributed images from the users' imaging devices (e.g., a light sensitive sensor of a digital camera). In one implementation a facial/pattern recognition algorithm aids in selecting the sub-image. In another implementation, each sub-image is determined according to the assigned partition displayed in the combined image. For example, if a collaborator's sub-image is displayed in partition “1” of FIG. 7B, then the pixels of the sub-image would correspond to a shape and location of pixels on the collaborator's digital camera sensor corresponding to the shape and location of partition “1”. The respective collaborators would then center and optimize their respective sub-images by manually moving and tilting their respective cameras to capture a desired field (e.g., the sub-image would include the user's face when the user is taking a selfie).

The boundaries between the sub-images can be blended as discussed in relation to step 160 of method 100, except there need not be one collaborator's image that is selected as the primary image. For example, all of the sub-image partitions can be equal in size and can occupy the entire combined image frame. Also, for adjusting the dark level and the color, for example, the primary image could be functionally taken as the combination of all other sub-images except the current sub-image under consideration. Further, the users can define a linewidth of the blending regions between the partitions, and the blending function can be performed by a graded change in the respective transparencies of the sub-images, or by blurring the images, or by both a graded change in the transparency and blurring the sub-image boundaries.

In one implementation, the real-time group-selfie image is displayed simultaneously in all of the users' devices. Further, the sub-images are continuously updated according to repeated transmissions of updated sub-images from the respective collaborators. Thus, in step 186, the group-selfie display is continuously updated. In another implementation, only the initiating user's device displays all of the sub-images, unless and until a group-selfie is captured on the initiating user's device and then the captured group selfie is shared with the group of collaborators. This alternative implementation is advantageous when limited bandwidth is available on the network communication channel. Additionally, the method 100″ can include audio communication among collaborators to discuss and coordinate the group selfie.

In step 180 of process 190, an invitee receives an invitation/request to collaborate in a group selfie. At step 182 of process 190, the invitee either accepts or declines the invitation/request to collaborate. If the invitee declines the invitation/request to collaborate, then the invitee proceeds to step 192 by returning to the “home/contacts” screen and to the main menu. On the other hand, if the invitee accepts the invitation/request to collaborate, then process 190 proceeds to step 184, wherein the invitee is linked into the group selfie, after which process 190 proceeds to step 186.

At step 186, the sub-images of the contributors are displayed in the group-selfie display and continuously updated as discussed above in reference to step 186. From step 186 a contributor can choose to capture an image of the group selfie and save the group selfie image in a computer readable memory by, e.g., selecting an “acquire image” button such as the “acquire image” button/icon shown in FIG. 2G. In one implementation of step 186, the “group-selfie display” screen can be the screen shown in FIG. 2G. After selecting the “acquire image” button, process 186 proceeds to inquiry 188, wherein the capture image branch is taken by proceeding to step 189, wherein the group selfie image displayed at the time of capture is stored into memory and then the process 190 returns to step 186.

When an exit option is selected in the “group-selfie display” screen, then process 190 proceeds from step 186 through the inquiry at step 188 to the exit branch, wherein the group-selfie process 190 exits back to step 130″ by proceeding to step 192 and then returning to step 130″ of method 100″. If a menu option other than the real-time group-selfie option is selected from the menu in step 130″, then method 100″ proceeds to process 139.

FIG. 1E shows the steps of process 139, which are similar to the corresponding steps 140′ through 175′ of method 100′ discussed above. For example, step 140″ performs the function of acquiring a new image by, e.g., displaying a “new image” screen as shown in FIG. 2G and as discussed in relation to step 140 of method 100 and also step 140′ of method 100′. Similarly, steps 145″ through 175″ correspond to the respective steps 145′ through 175′ of method 100′. After the completion of any of steps 140″ through 175″, process 139 proceeds to step 192, wherein process 139 is completed and method 100″ is returned to at step 130″.

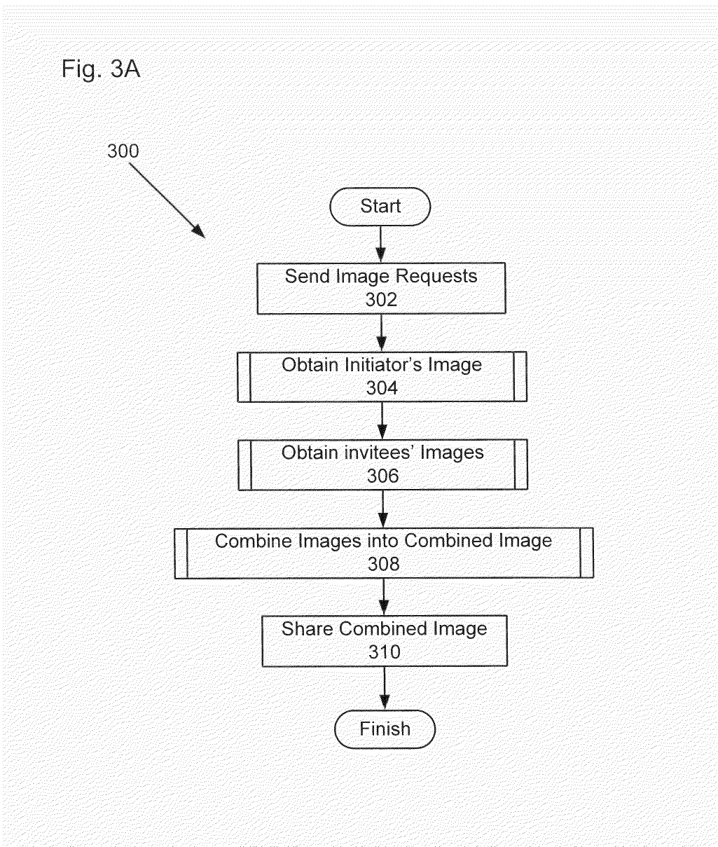

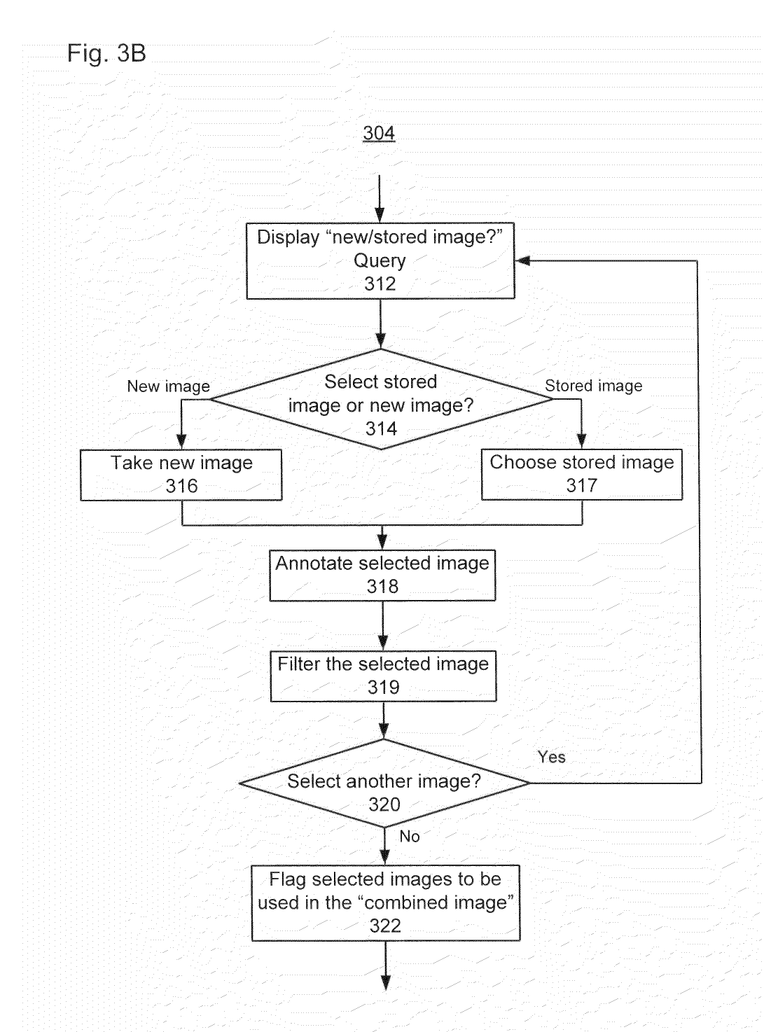

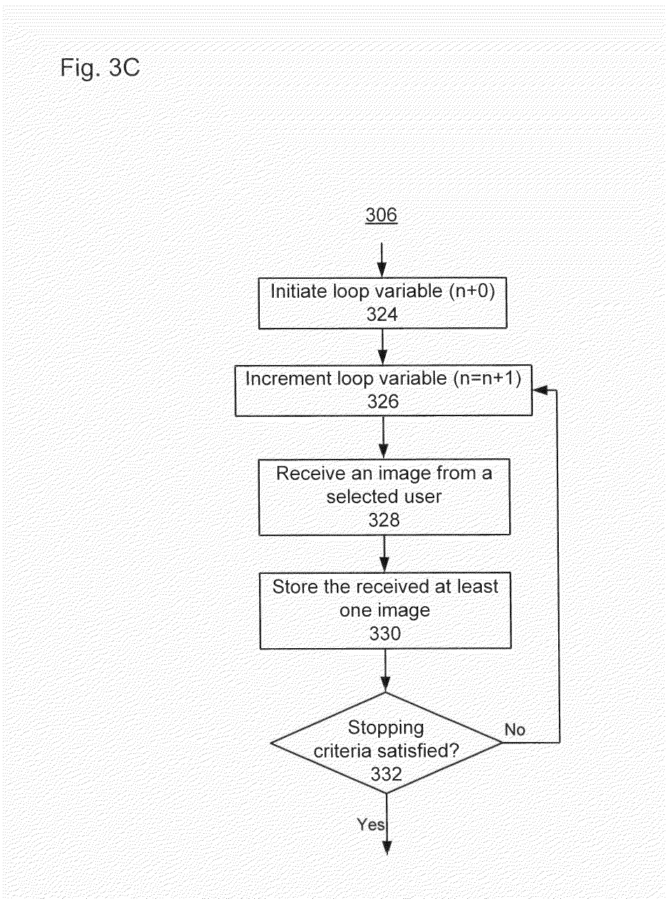

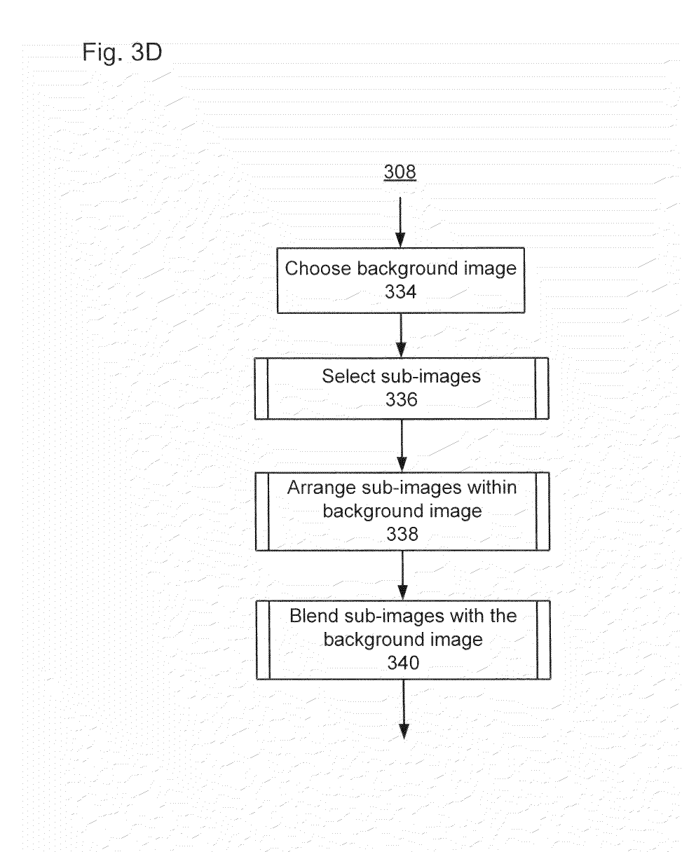

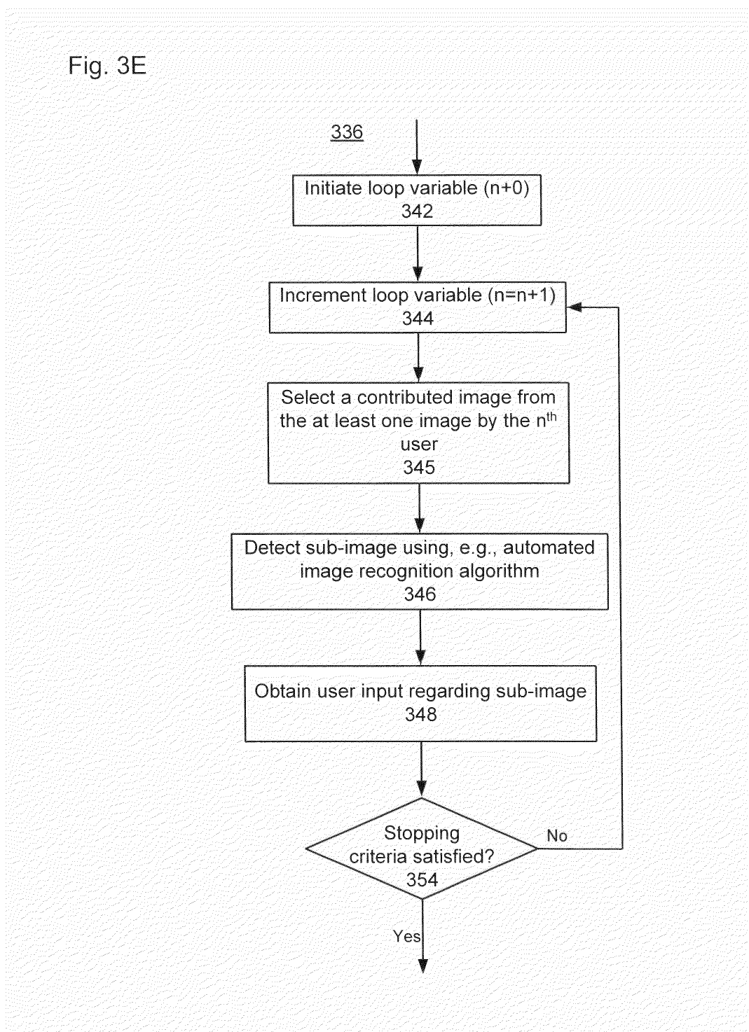

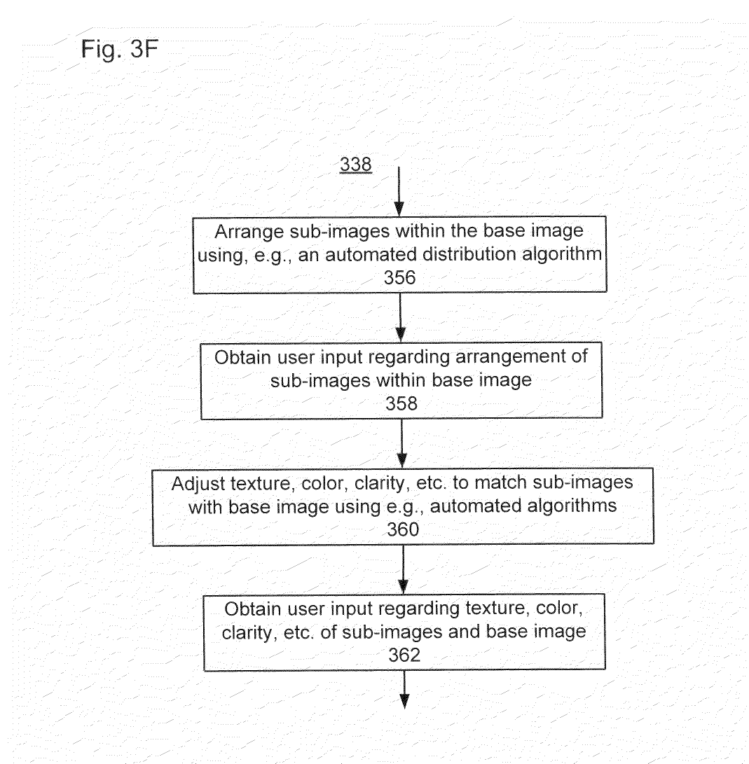

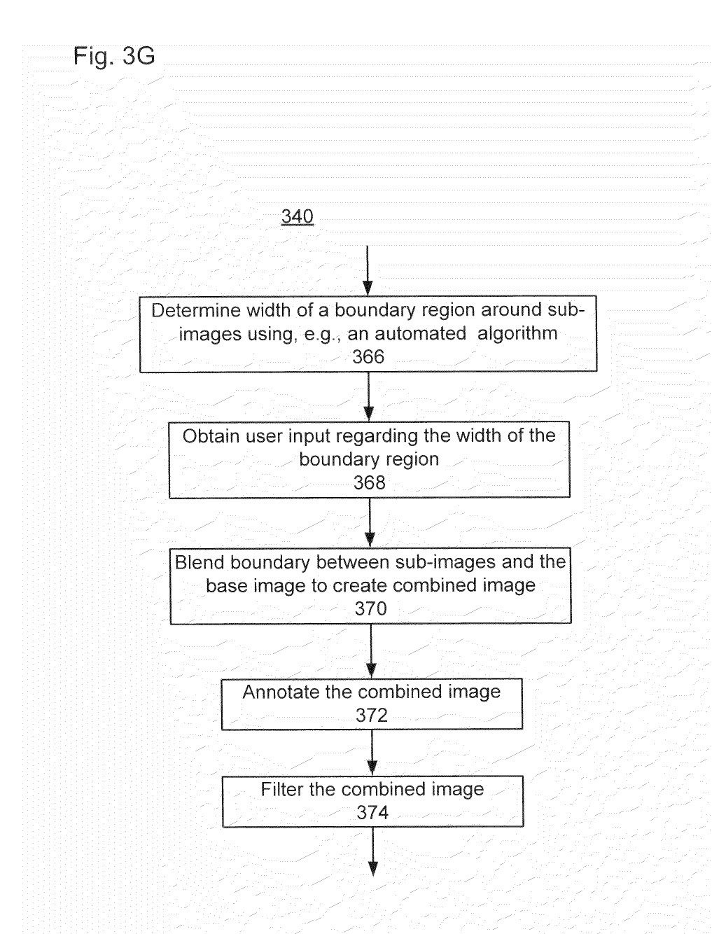

FIG. 3A shows a method 300 for a user of a digital-image device to initiate the creation of a combined image or group selfie. The first step 302 of method 300 is to send a request to a list of selected users. Step 302 can include selecting contacts from a contact list and then sending the group-selfie request, or sending the group-selfie request to a predefined list of selected users.

Next, at process 304 of method 300, the image of the initiating user is obtained; followed by obtaining the invitees' images in process 306.

After all of the images have been contributed and obtained, then the method 300 proceeds to process 308, wherein the contributors' images are combined. The determination of whether all of the images have been obtained can be based on receiving a signal from the invitee's indicating whether the each respective invitee has accepted or declined the group-selfie request. Additionally, a time limit may be set, after which a non-response to the request is determined to be a denial of the request.

Finally, after the combined image has been created from the contributors' images, the combined image can be shared and distributed among the contributors, as indicated by step 310 of method 300.

FIG. 3B shows an example of a process 304 to obtain an image from the initiator of the group selfie. The first step 312 of process 304 is determining whether the initiator's contributed image will be a new or a stored image. After obtaining the initiator's input at step 312, the process 304 proceeds to query, at step 314, whether the user's input indicates either a new image or a stored image. Depending on whether the user's input indicates either a new image or a stored image, the process 304 will proceed from step 314 to either step 316 or step 317 respectively. New and stored images can respectively be obtained as discussed in relation to step 140 and 145 of method 100 and as discussed in relation to step 140′ and 145′ of method 100′.

After obtaining the image to be contributed, process 304 proceeds to annotate and filter the image in steps 318 and 319 respectively. Filtering and annotating can be performed as discussed in relation to the filtering and annotating steps 150 and 155 of method 100.

In one implementation, more than one image can be contributed by the initiator. If the initiator elects to send another image then at step 320, the process 304 will continue to step 312 and another new or stored image will be obtained, annotated, and filtered to be contributed to the combined image or group selfie. Otherwise, the process 304 continues to step 322 wherein each of the contributed images is designated or flagged as being contributed to the group selfie.

In one implementation, process 304 can also be used by an invitee of a group-selfie request to select at least one contributed image to send in order to become part of the combined image or group selfie.

FIG. 3C shows a process of an initiator receiving and counting the number of received images to become part of the combined image or group selfie. First, a loop variable is initialized at step 324. Next the loop variable is incremented at step 326. At step 328, an image is received from one of the selected user contributing to the group selfie. The images can include metadata indicating, e.g., who sent the image, the date and time the image was sent, the date and time the image was acquired, the location the image was acquired, etc. In step 330, the received images are stored in memory. At step 332, the loop is stopped when the stopping criteria are satisfied, such as when images have been received from all contributors or a time limit has expired. Otherwise, process 306 continues by returning to step 326.

FIG. 3D shows an example of process 308, wherein the contributed images are combined to create a group selfie. In step 334, one of the contributed images is selected as a primary, base, or background image into which the sub-images from the other contributed images will be incorporated and blended. Next, at process 336, sub-images are selected from the contributed images. Then, at process 338, sub-images are arranged within the background/primary image. Finally, at process 340, the boundaries between the sub-images and the background/primary image are blended.

FIG. 3E shows an example of process 336 to select sub-images from the contributed images. First, a loop variable is initialized at step 342. Next the loop variable is incremented at step 344. At step 345, a contributed image is selected from the at least one contributed images from the n^{th} collaborator, wherein n is the loop count variable. Next, at step 346, a sub-image is detected using, e.g., an automated algorithm.

For example, the automated algorithm could use a face detection method to detect faces within the contributed image. There are numerous methods that have been proposed to detect faces in grey-scale images and also in color images. For example, among the face detection methods, the methods based on learning algorithms have attracted much attention and have demonstrated excellent results. These data driven methods rely heavily on training sets and suitable databases. In one implementation, this training can be performed previously with the results stored in memory.

Further, face detection can be performed using a knowledge-based method, wherein known features typically present in a face are encoded as rules. Usually, these rules capture the relationships between facial features. A knowledge-based method is advantageous for face localization.

Also, the face detection algorithm can be a feature invariant algorithm. These algorithms aim to find structural features that exist even when the pose, viewpoint, or lighting conditions vary, and then use these invariant structural features to locate faces. These methods are also advantageous for face localization.

Furthermore, the face detection algorithm can be a template-matching algorithm. In a template-matching algorithm, several standard patterns of a face are stored to describe the face as a whole or the facial features separately. The correlations between an input image and the stored patterns are computed for detection.

Additionally, the face detection algorithm can be an appearance-based algorithm. In contrast to template matching, the models (or templates) in the appearance-based algorithm are learned from a set of training images which should capture the representative variability of facial appearance. These learned models are then used for detection.

In addition to detecting and locating faces in the contributed images, an automated algorithm can be used to determine a boundary around each face in order to define a sub-image corresponding to the face. For example, an edge-detection method could be used to aid in determining a line located at the boundary of the face sub-image. Examples of edge-detection algorithms that could be used, include: Canny edge detection methods, thresholding and linking edge detection methods, edge thinning methods, phase congruency-based methods (aka phase visual coherence methods), first order methods (e.g., using the Sobel operator), and higher-order method (e.g., differential edge detection).

After the automated sub-image detection method of step 346 is performed, process 346 proceeds to step 348, wherein user input optimizes the sub-image selected. For example, if more than one sub-image is detected then the user can select which sub-images are to be incorporated into the combined image. Further, the user can optimize the boundary demarking the periphery of the sub-images. Alternatively, a user can ignore the result of the automated algorithm and instead choose to manually draw boundaries defining sub-images according to user input rather than automated face/object recognition.

At step 354 of process 336, there is an inquiry as to whether the stopping criteria have been satisfied. The stopping criteria are satisfied when all of the sub-images have been selected (e.g., one sub-image for each of the contributor) as indicated by the loop variable. If the stopping criteria are not satisfied then process 354 returns to step 344. Otherwise, process 354 ends.

FIG. 3F shows an example of process 338 in which the sub-images are arranged within the background/primary image. The first step 356 of process 338 uses an automated algorithm to distribute the sub-images within the base or background image (also referred to as the primary image). The automated algorithm searches for the arrangement of sub-images resulting in the least overlap among the images.

Next, at step 358 of process 338, user input is used to optimize the arrangement. For example, the user can select and drag the sub-images to move/change their position within the base image. Further the user can select sub-images and resize or stretch them in order to improve the visual coherence of the combined images.

Next, at step 360 of process 338, an automated algorithm is used to adjust the color, texture, dark level, etc. of the sub-images in order to improve the visual coherence of the combined images. As discussed in reference to step 160 of method 100 in FIG. 1A, the average color, texture, dark level, etc. of the base image can be calculated and the sub-images can be automatically adjusted to match the base image. Alternatively, average color, texture, dark level, etc. of the base image in the region of the boundary between the respective sub-image and the base image can be calculated and then the sub-images can be automatically adjusted to match these regional averages.

Next, at step 362 of process 338, user input is used to optimize the color, texture, dark level, etc. of the sub-images in order to improve the visual coherence of the combined images. For example, a user can select a sub-image and adjust the color, texture, dark level, contrast, etc. using a popup window having corresponding controls for the color, texture, dark level, contrast, etc.

FIG. 3G shows an example of process 340 in which the boundaries between the sub-images and the background/primary image are blended. In step 366, the width of a boundary region demarking the border between each sub-image and the base image is determined. In one implementation, the width of the boundary region can vary among the sub-images. Further, the width of the boundary region can also vary along the border of each sub-image. In one implementation, the optimal width of the boundary region is first estimated using an automated algorithm accounting for the proximity between the sub-images (e.g., closer proximity correlates with thinner boundary regions) and the contrast between the sub-image and the base image (e.g., more similarities and a stronger correlation between the sub-image and base image would result in thinner boundary regions).

Next, at step 368, the input of a user is used to manual adjust and optimize the width of the boundary region. Further, the input of the user can select between various types of blending between the sub-image and the base image. For example, types of blending can include a tapered transition in the transparency of the sub-image, a blurring of the sub-image and base image at the boundary, and a combination of tapered adjustment of the transparency of the sub-image and blurring the boundary.

Next, at step 372, the combined image can be annotated similar to the annotation discussed in relation to step 155 of method 100.

Next, at step 374, the combined image can be filtered similar to the filtering discussed in relation to step 150 of method 100.

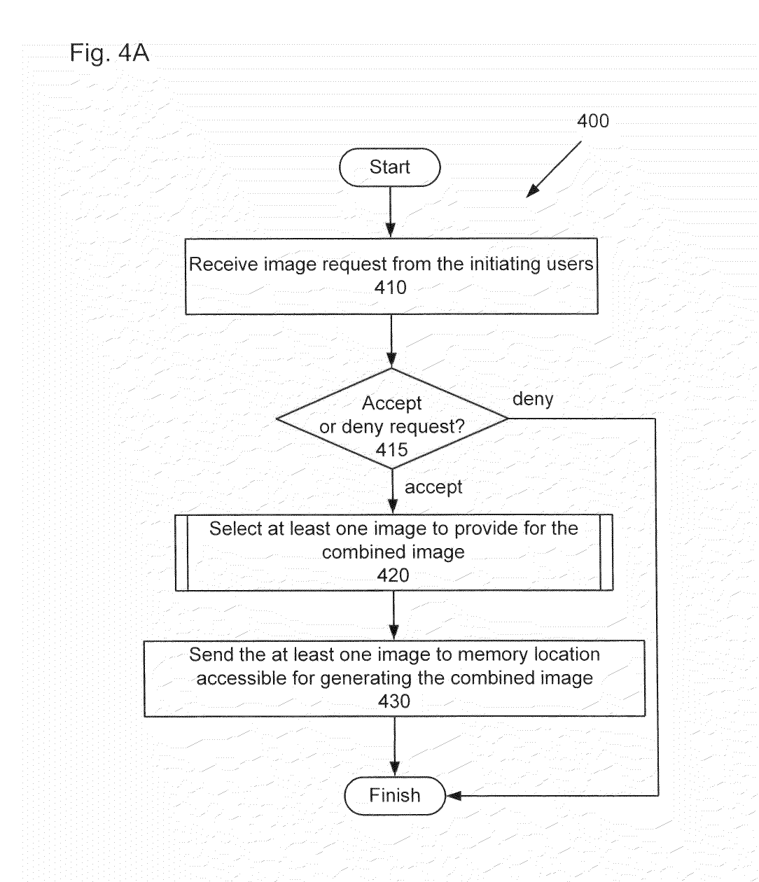

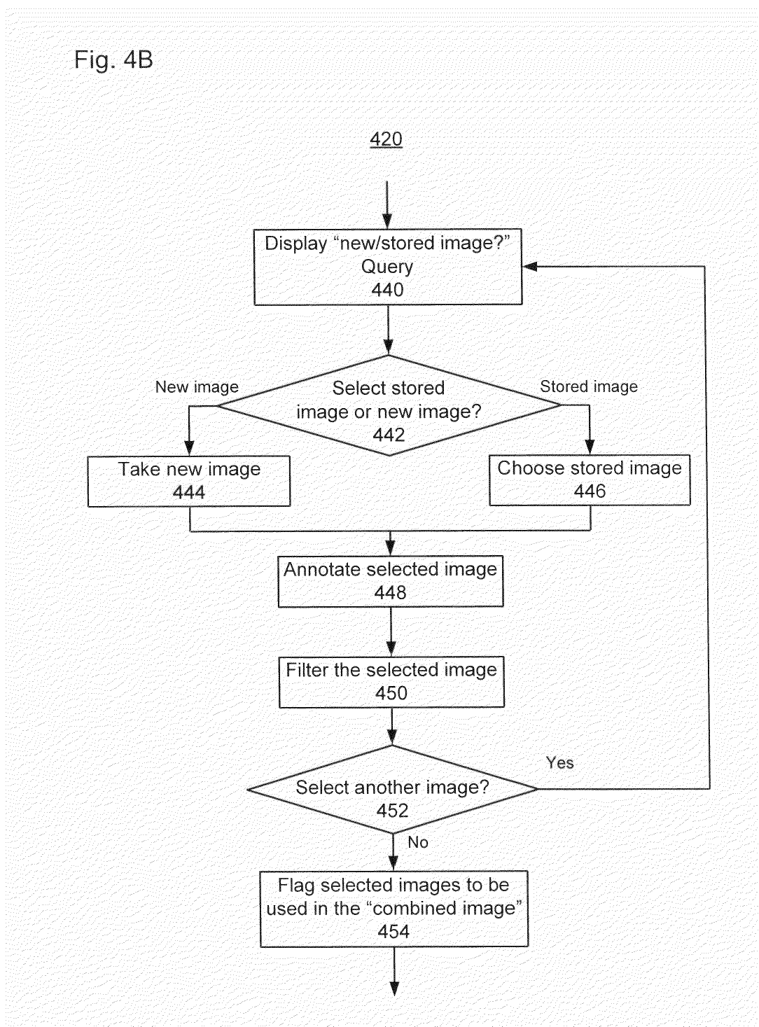

FIG. 4A shows a method 400 of an invitee receiving a group-selfie request, accepting the request, and then contributing an image to the group selfie. In step 410, the user of an image device (e.g., a smart-phone user) receives a group-selfie request, requesting that the user—an invitee—contribute an image to be used in creating a group selfie.

In step 415, the invitee either accepts or denies the request. If the invitee denies the request, then method 400 ends. If the invitee accepts the request, then method 400 proceeds to process 420, wherein the invitee selects at least one image to contribute to the group selfie.

After selecting the image to contribute, the invitee then sends the image to the initiator of the group-selfie request, or the invitee sends the image to be stored in a memory accessible by the initiator of the group-selfie request.

In one implementation, the contributor of the image (e.g., the invitee sending the requested/contributed image) performs the steps of selecting the sub-image and adjusting the boundary of the sub-image before sending the contributed image. Also, in one implementation, the border defining the sub-image is included in the metadata packaged with the contributed image.

FIG. 4B shows an example of the process 420, wherein the invitee selects at least one image to contribute to the group selfie. In one implementation, process 420 is similar to process 304 of method 300.

The first step 440 of process 420 is determining whether the initiator's contributed image will be a new or a stored image. After obtaining the initiator's input at step 440, the process 420 proceeds to query, at step 442. Depending on whether the user's input indicates either a new image or a stored image, the process 420 will proceed from step 442 to either step 444 or step 446 respectively. New and stored images can respectively be obtained as discussed in relation to step 140 and 145 of method 100 and as discussed in relation to step 140′ and 145′ of method 100′.

After obtaining the image to be contributed, process 420 proceeds to annotate and filter the image in steps 448 and 450 respectively. Filtering and annotating can be performed as discussed in relation to the filtering and annotating steps 150 and 155 of method 100.

In one implementation, more than one image can be contributed by the initiator. If the initiator elects to send another image then at step 452, the process 420 will continue to step 440 and another new or stored image will be obtained, annotated, and filtered to be contributed to the combined image or group selfie. Otherwise, the process 420 continues to step 454 wherein each of the contributed images is designated or flagged to be sent as contributions to the group selfie.

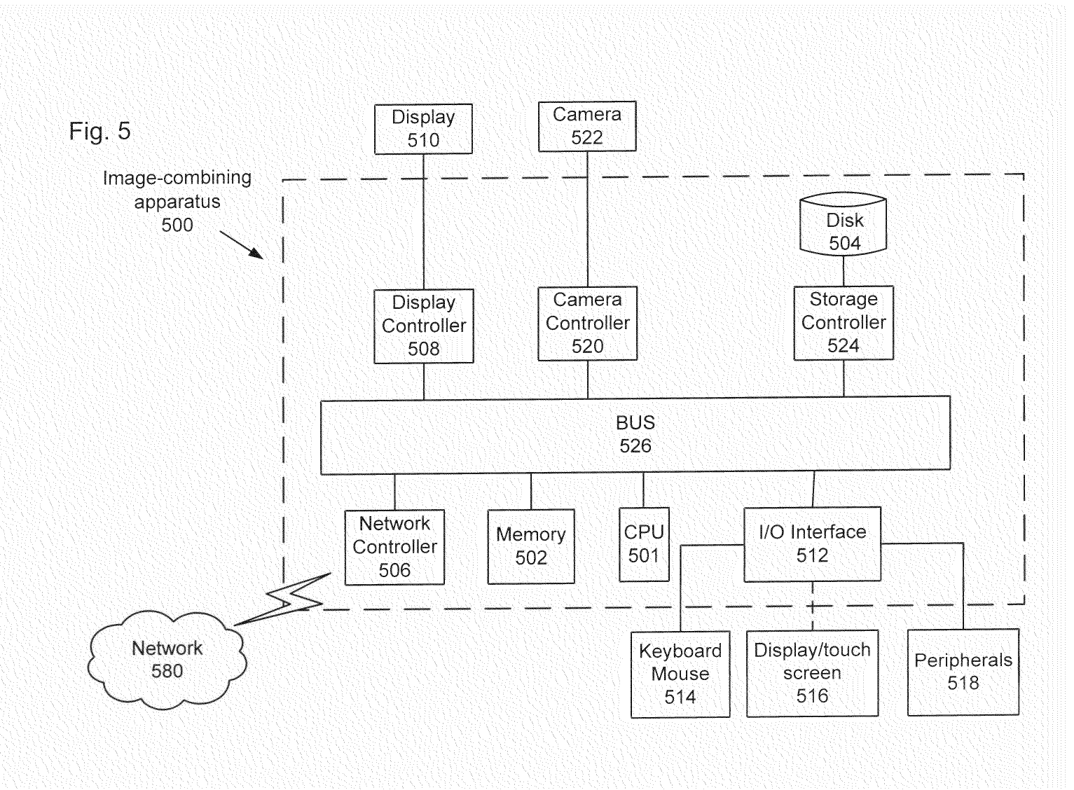

Next, a hardware description of the image-combining apparatus 500 according to exemplary embodiments is described with reference to FIG. 5. In FIG. 5, the image-combining apparatus 500 includes a CPU 501 which performs the processes described above including methods 100, 100′, 100″, 300, and 400, wherein a combined image is created from contributed images. The image-combining apparatus 500 can optionally include a digital camera to acquire the images as well as to combine the contributed images into a combined image or group selfie, or alternatively the image-combining apparatus 500 can obtain the contributed images from other devices, such as a camera phone, a desk-top computer, and a tablet computer, before performing the function of combining the contributed images into the combined image or group selfie.

The process data and instructions for performing the methods described herein may be stored in a memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the image-combining apparatus 500 communicates, such as a server or computer.

Further, the claimed advancements may be provided as a utility application, background daemon, or component of an operating system, or combination thereof, executing in conjunction with CPU 501 and an operating system such as Microsoft Windows 7, UNIX, Solaris, LINUX, Apple MAC-OS and other systems known to those skilled in the art.

CPU 501 may be a Xenon or Core processor from Intel of America or an Opteron processor from AMD of America, or may be other processor types that would be recognized by one of ordinary skill in the art. Alternatively, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

The image-combining apparatus 500 in FIG. 5 also includes a network controller 506, such as an Intel Ethernet PRO network interface card from Intel Corporation of America, for interfacing with network 580. As can be appreciated, the network 580 can be a public network, such as the Internet, or a private network such as an LAN or WAN network, or any combination thereof and can also include PSTN or ISDN sub-networks. The network 580 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The image-combining apparatus 500 further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface 512 also connects to a variety of peripherals 518 including printers and scanners, such as an OfficeJet or DeskJet from Hewlett Packard.

A camera controller 520 is also provided in the image-combining apparatus 500 to interface with camera 522 thereby providing functionality to capture images.

The general purpose storage controller 524 connects the storage medium disk 504 with communication bus 526, which may be an ISA, EISA, VESA, PCI, or similar, for interconnecting all of the components of the image-combining apparatus 500. A description of the general features and functionality of the display 510, keyboard and/or mouse 514, as well as the display controller 508, storage controller 524, network controller 506, camera controller 520, and general purpose I/O interface 512 is omitted herein for brevity as these features are known.

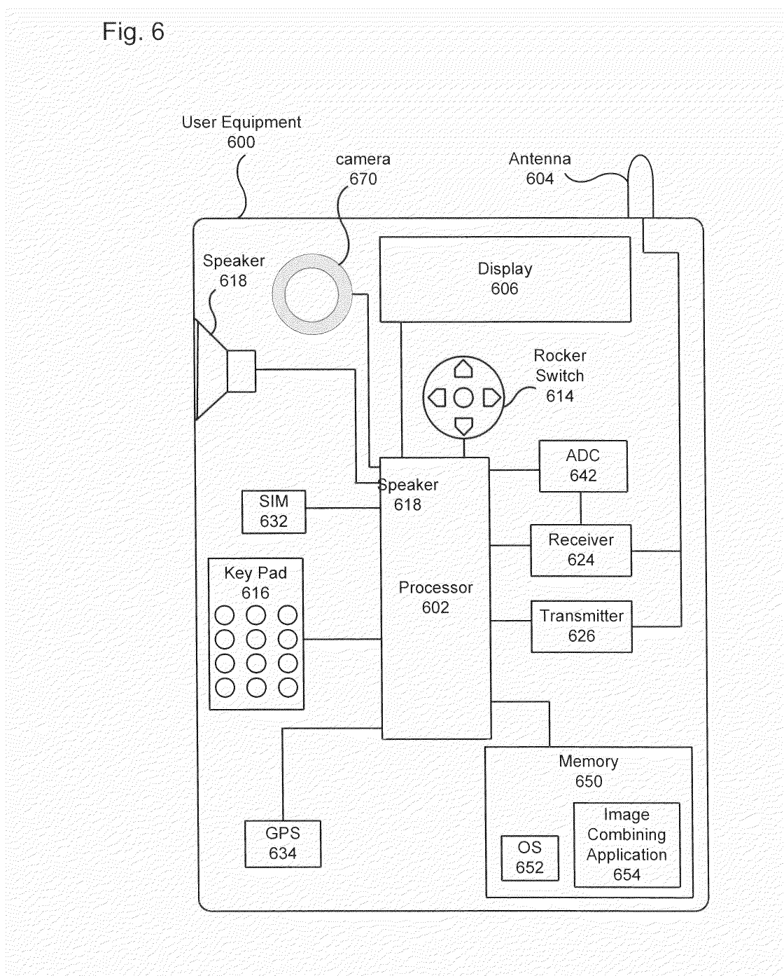

FIG. 6 shows a block diagram illustrating an user equipment (UE) 600 according to an embodiment. In one implementation, the UE 600 can perform the function of the image combining apparatus by performing the methods discussed herein. In one implementation, the UE 600 can interact with other user equipments and image combining connected through a wireless or wired network to perform collectively the methods of acquiring, editing, sending, receiving, and combining images, as discussed in reference to methods 100, 100′, 100″, 300, and 400, to create a combined image. Moreover, the methods described herein can be performed by some of the steps being performed by the UE 600, and other of the steps being performed using cloud computing. For example, in one implementation, less computationally intensive steps such as the step of selecting users and sending a group-selfie request to the selected user can be performed on the UE 600, and more computationally intensive image processing steps such as filtering and automated detection of sub-images and/or faces can be performed using cloud computing to limit the computational and storage burden on the UE 600 where size, weight, and power at are at premium.

Returning to FIG. 6, the UE 600 provides processing circuitry configured to perform the methods described herein. For example, the UE 600 may include a processor 602 coupled to an internal memory 650, to a display 606 and to a subscriber identity module (SIM) 632 or similar removable memory unit. Additionally, the UE 600 may have an antenna 604 that is connected to a transmitter 626 and a receiver 225 coupled to the processor 602. In some implementations, the receiver 624 and portions of the processor 602 and memory 650 may be used for multi-network communications. In additional embodiments the UE 600 may have multiple antennas 604, receivers 624, and/or transmitters 626. The UE 600 may also include a key pad 616 or miniature keyboard and menu selection buttons or rocker 614 for receiving user inputs. The UE 600 may also include a GPS device 634 coupled to the processor and used for determining time and the location coordinates of the UE 600. Additionally, the display 606 may be a touch-sensitive device that may be configured to receive user inputs and a camera 670 to acquire digital images.

The processor 602 may be any programmable microprocessor, microcomputer or multiple processor chip or chips that can be configured by software instructions (applications) to perform a variety of functions, including the functions of the various embodiments described herein. In one embodiment, the UE 600 may include multiple processors 602, such as one processor dedicated to cellular and/or wireless communication functions and one processor dedicated to running other applications.

Typically, software applications may be stored in the internal memory 650 before they are accessed and loaded into the processor 602. In one embodiment, the processor 602 may include or have access to an internal memory 650 sufficient to store the application software instructions. The memory may also include an operating system 652. In one embodiment, the memory also includes the image combining application 654 that preforms the method of combining images into a combined image as described herein, thus providing additional functionality to the UE 600.

Additionally, the internal memory 650 may be a volatile or nonvolatile memory, such as flash memory, or a mixture of both. For the purposes of this description, a general reference to memory refers to all memory accessible by the processor 602, including internal memory 650, removable memory plugged into the computing device, and memory within the processor 602 itself, including the secure memory.

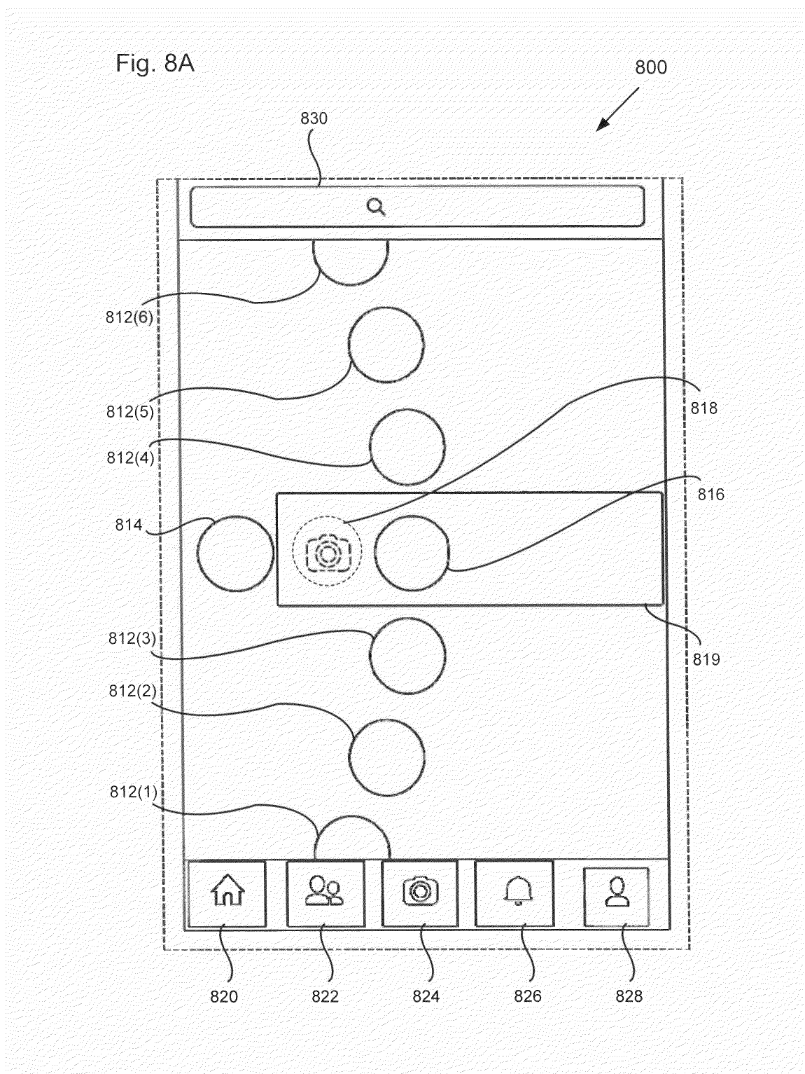

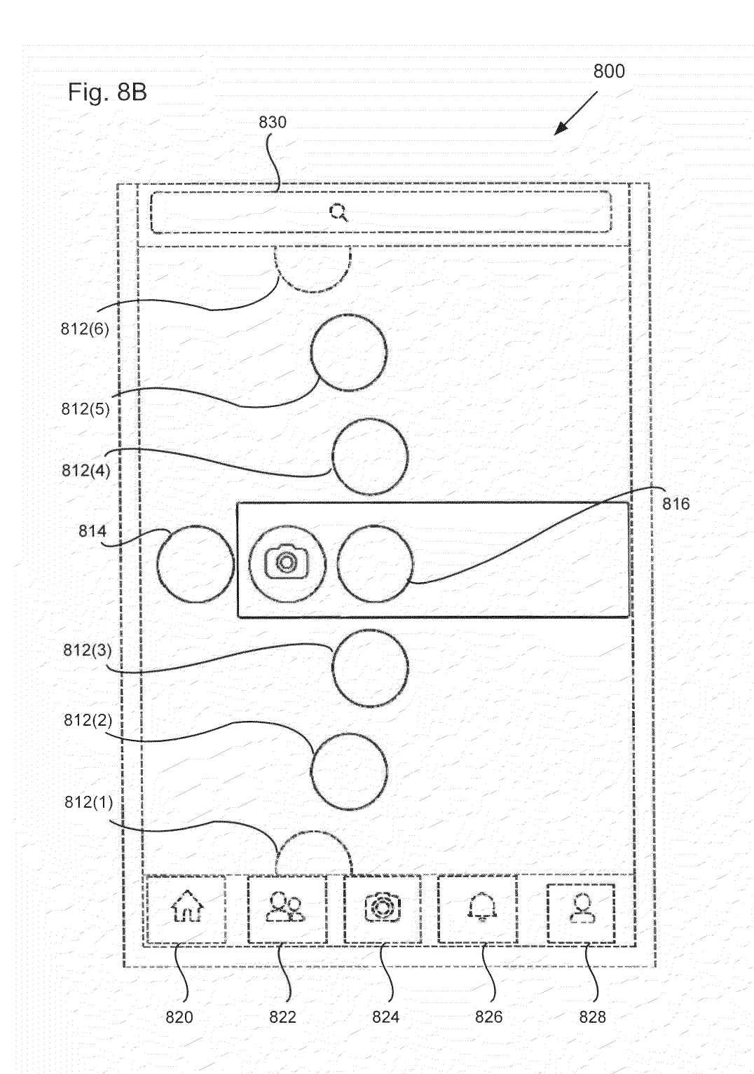

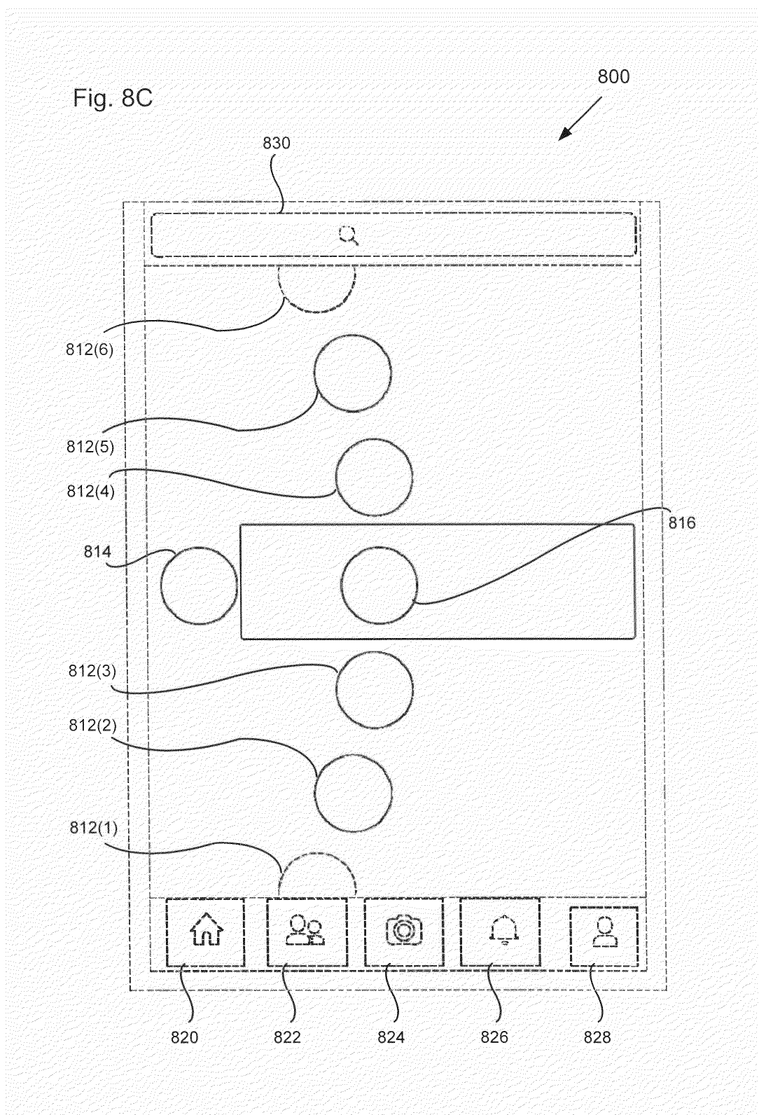

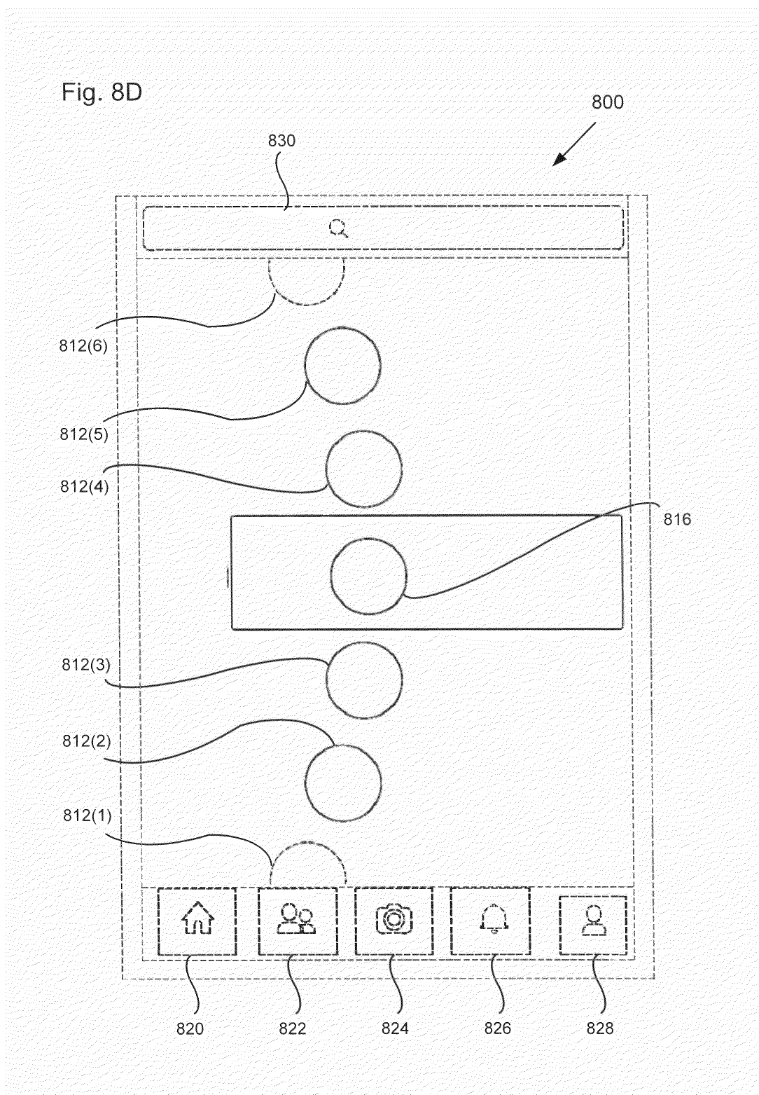

FIGS. 8A, 8B, 8C, and 8D show drawings of one implementation of a “select contact” screen 800. This “select contact” screen 800 can perform the functions of selecting a contact and initiating a group-selfie request to the selected contact. Thus, the “select contact” screen can perform similar functions to the “contacts” screen shown in FIG. 2D and the “request group selfie” screen shown in FIG. 2K.

The “select contact” screen includes menu icons, including: a home icon 820, a contacts icon 822, a take-selfie icon 824, a notifications icon 826, and a profile icon 828. In one implementation, selecting the home icon 820 causes a home screen to be displayed. In another implementation, selecting the home icon 820 causes a time-line screen to be displayed. In one implementation, selecting the contacts icon 822 causes a contacts screen to be displayed. In one implementation, selecting the take-selfie icon 824 causes the “select contact” screen 800 to be displayed, and the “select contact” screen 800 enables the user to select a contact in order to initiate a group selfie with the selected contact. In one implementation, selecting the notifications icon 826 causes a notifications screen to be displayed. In one implementation, selecting the profile icon 828 causes a “select group-selfie” screen 900 to be displayed. In another implantation, selecting the profile icon 828 causes a profile screen to be displayed, where the profile screen enables the user to access group selfies and individual images of the user and/or images shared by other users (e.g., “friends” and contacts).

The “select contact” screen includes a series of icons/thumbnail images corresponding to the list of contacts 812(1), 812(2), 812(3), 812(4), 812(5), and 812(6) and including the icon/thumbnail 816 corresponding to the selected contact. These thumbnail images 816, 812(1), 812(2), 812(3), 812(4), 812(5), and 812(6) are arranged in an arc, and, in one implementation, a user can swipe the screen of a touch-screen s device displaying screen 800 to cause the thumbnails to cycle around in a fashion similar to an old fashioned rotary dial telephone. Further, the “select contact” screen includes an icon/thumbnail image 814 corresponding to the user. The “select contact” screen includes a text search box 830 to enter a search name in order to perform a search for contacts corresponding to the search name. Additionally, the “select contact” screen includes a take-image icon 818. In one implementation, selecting the take-image icon 818 initiates a group-selfies request to the selected contact corresponding to the thumbnail image 816 in the selection box 819. Also, the selection of the take-image icon 818 initiates the process of the user selecting/capturing a digital image that the user then contributes to the group selfie. In one implementation, the thumbnail images 816, 812(1), 812(2), 812(3), 812(4), 812(5), and 812(6) corresponding to the contacts include an indicator whether the respective contact is online or offline.

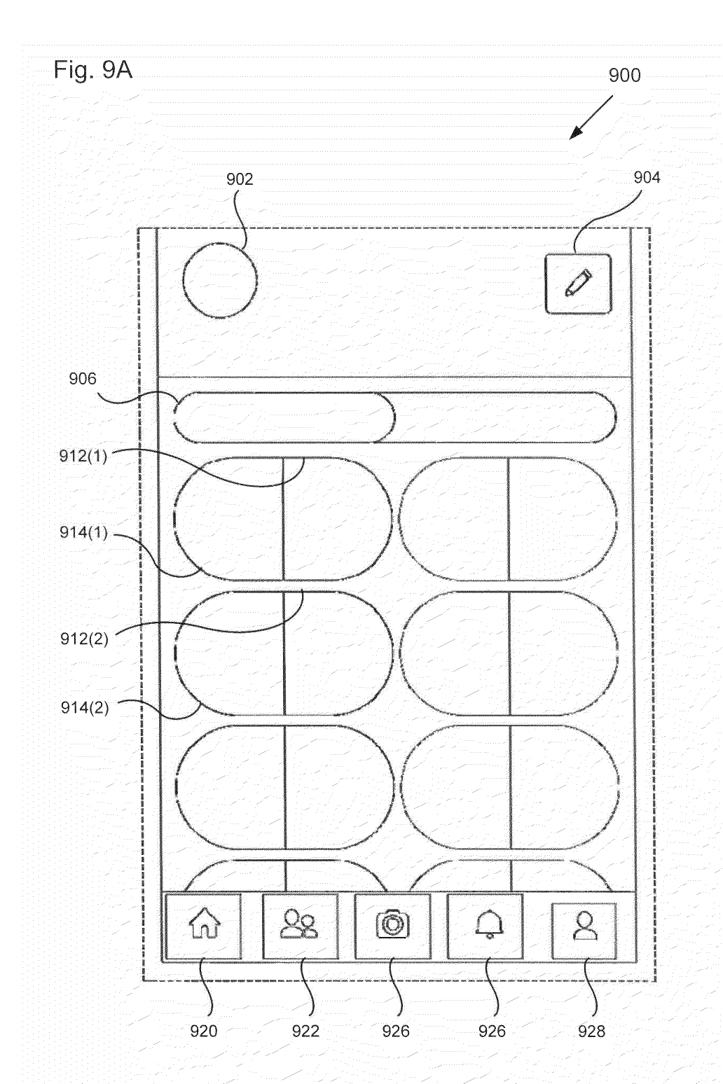

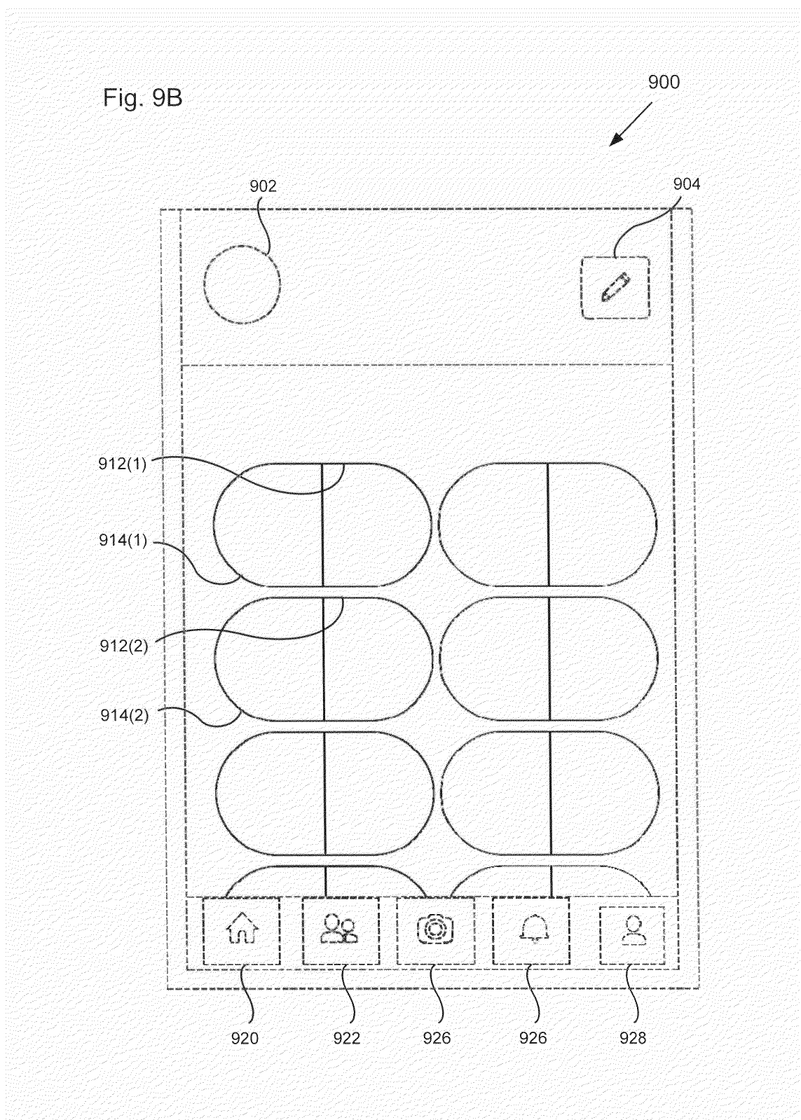

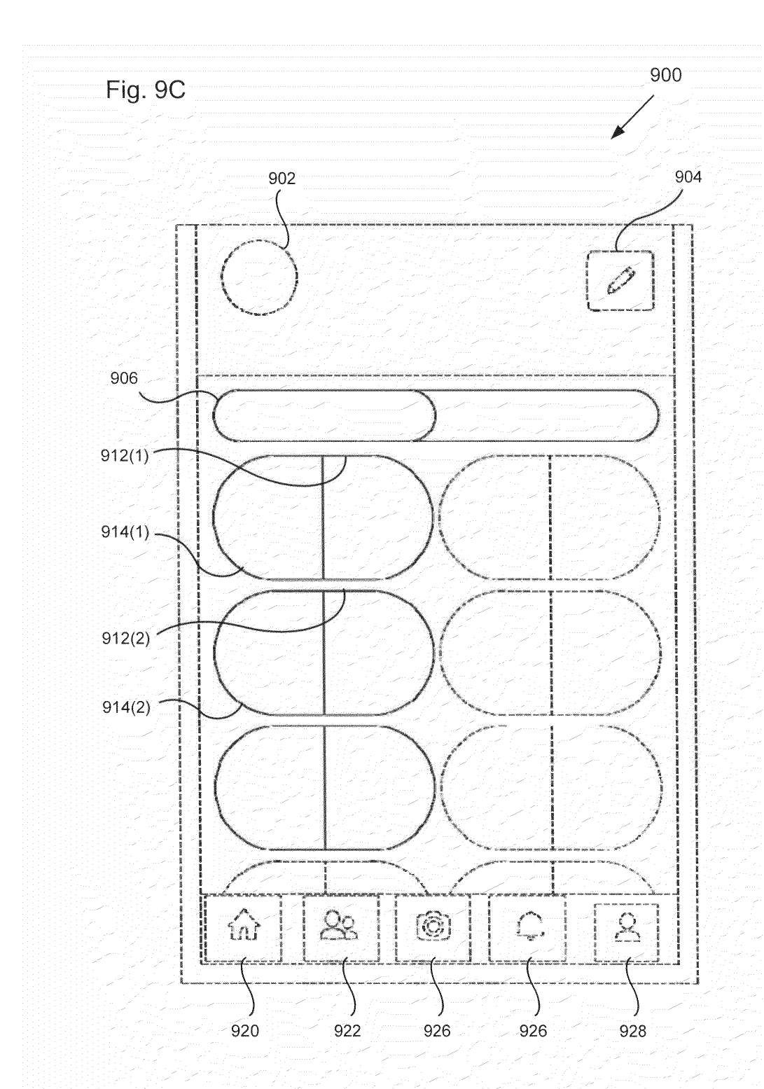

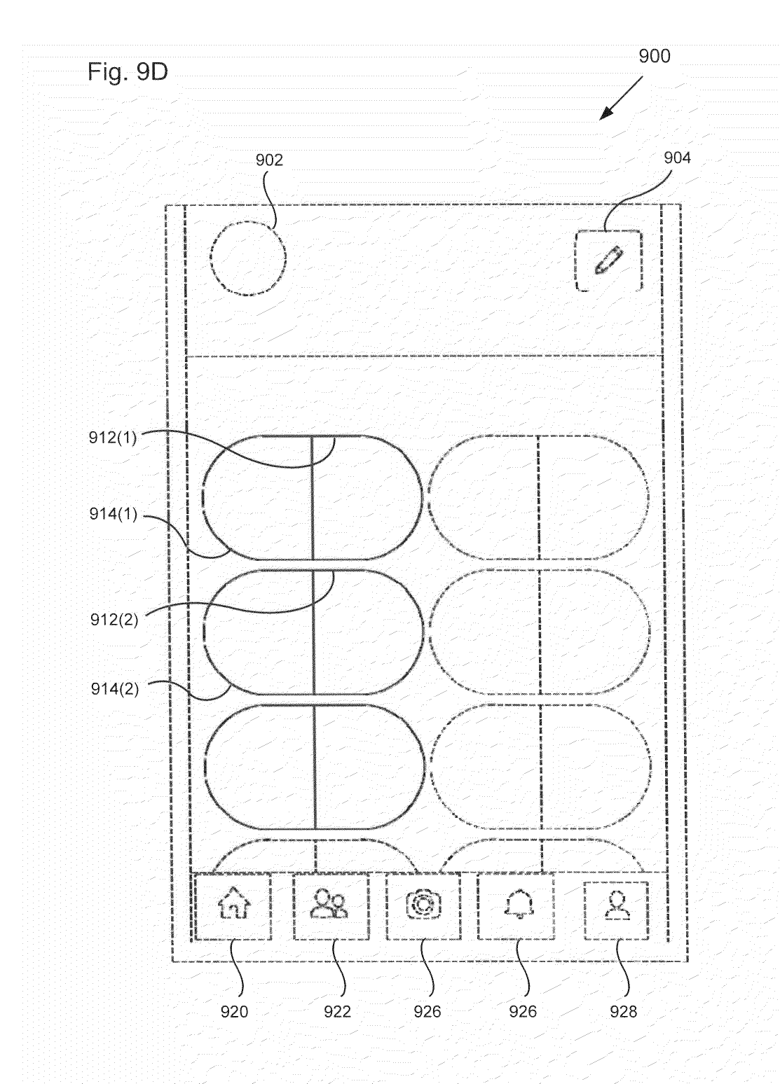

FIGS. 9A, 9B, 9C, and 9D show drawings of one implementation of a “select group-selfie” screen 900. This “select group-selfie” screen can perform the functions of selecting a group-selfie of the user or of a contact for viewing and/or commenting. Thus, the “select group-selfie” screen can perform similar functions to the “a “scroll/view image” screen shown in FIG. 2F.

The “select contact” screen includes menu icons, including: a home icon 920, a contacts icon 922, a take-selfie icon 924, a notifications icon 926, and a profile icon 928. In one implementation, selecting the home icon 920 causes a home screen to be displayed. In another implementation, selecting the home icon 920 causes a time-line screen to be displayed. In one implementation, selecting the contacts icon 922 causes a contacts screen to be displayed. In one implementation, selecting the take-selfie icon 924 causes the “select contact” screen 800 to be displayed. In one implementation, selecting the notifications icon 926 causes a notifications screen to be displayed. In one implementation, selecting the profile icon 928 causes a “select group-selfie” screen 900 to be displayed. In another implantation, selecting the profile icon 928 causes a profile screen to be displayed, where the profile screen enables the user to access group selfies and individual images of the user and images shared by other users (e.g., “friends” and contacts).

The profile-owner thumbnail 902 displays a thumbnail, pictogram, or icon corresponding to the user whose profile of group selfies is being displayed. The profile owner of the group-selfie profile can be the user of the device displaying screen 900, or can be a contact of the user, or can be some other user who has enabled their group-selfies to be viewed by the general public. In one implementation, the profile-owner thumbnail 902 includes an indicator of whether the profile owner is online or offline.

The slide bar toggle switch 906 enables a user to select between viewing public and private group selfies. Public group selfies have a public security/privacy setting allowing the public to view the group selfies. Private group selfies include a private security/privacy setting allowing only select users with predefined security permissions to access the private group selfies. By sliding the slide bar toggle switch 906 to private, the user can view private group selfies. By sliding the slide bar toggle switch 906 to public, the user can view public group selfies.

The group-selfie selection regions are displayed as pairs of thumbnails. For example, a first thumbnail pair of a group-selfie selection region includes thumbnail 912(1) and thumbnail 914(1). Similarly, a second thumbnail pair includes thumbnail 912(2) and thumbnail 914(2), and so forth. In one implementation, the left and right-hand side thumbnails 912 and 914 of each pair can be a thumbnails corresponding to respective contributors to the group selfie. Thus, the thumbnails (e.g., 912(j) and 914(j), where j can be 1, 2, . . . N) would be of the users (e.g., a profile image of the user), rather than thumbnail depicting the contributed image in the group selfie. In one implementation, the left and right-hand side thumbnails 912 and 914 of each pair can be a thumbnails corresponding to respective digital images contributed to the group selfie. Thus, the thumbnails (e.g., 912(j) and 914(j), where j can be 1, 2, . . . N) would depict the contributed images in the group selfie rather than depicting the users contributing to the group selfie. By selecting a group-selfie selection region corresponding to a thumbnail pair 912(j) and 914(j), then the j^{th} group selfie is selected and displayed, for example. A user can then view the selected group selfie. Further, a comment icon 904 is displayed that enables a user to comment on a selected group selfie. For example, a user can select the comment icon 904 and then select-a group-selfie selection region to comment on the selected group selfie.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

1. A method of obtaining a group image, the method comprising:
sending, through a network, an image-request message to a plurality of selected users;
receiving, in response to the image-request message, a plurality of contributed images from the plurality of selected users;
selecting a plurality of sub-images from the plurality of contributed images, wherein each sub-image corresponds to a sub-image area within the respective contributed image; and
combining the plurality of sub-images, using processing circuitry, to create a combined image by arranging the plurality of sub-images within the combined image and blending a boundary region of each sub-image with the combined image.

2. The method according to claim 1, wherein the selecting the plurality of sub-images further includes dividing the combined image into a plurality of partitions assigned to respective sub-images, and each sub-image area of the respective sub-image has a predefined shape within the respective contributed image determined by the respective partition of the combined image.

3. The method according to claim 2, wherein the combined image is continuously updated to represent a real-time image, wherein the plurality of contributed images are continuously received and the sub-images are continuously updated and combined to create the combined image representing a real-time composite of the contributed images from the plurality of selected users.

4. The method according to claim 1, further comprising:
filtering the plurality of sub-images to harmonize a color and a dark level of the plurality of sub-images within the combined image.

5. The method according to claim 1, further comprising:
adjusting a shape and size of each of the plurality of sub-images to harmonize objects represented in the plurality of sub-images with shapes and sizes of objects represented in the combined image.

6. The method according to claim 1, further comprising:
adjusting a width of the boundary region of each sub-image; and
selecting a blending method whereby the boundary region of each sub-image is blended with the combined image.

7. The method according to claim 1, wherein the selecting the plurality of sub-images includes detecting faces in a contributed image of the plurality of contributed images and defining a region localized around each detected face as a facial area, and selecting at least one of the facial areas as the sub-image area of the contributed image.

8. The method according to claim 4, further comprising:
arranging the plurality of sub-images within the combined image to minimize overlap among the plurality of sub-images.

9. The method according to claim 1, further comprising:
determining a time window during which the plurality of contributed images can be received, and not receiving contributed images outside of the time window;
selecting the plurality of selected users from a list of contacts; and
annotating the combined image.

10. The method according to claim 2, further comprising:
selecting a configuration of the partitions of the combined image from a menu of partition configurations, wherein the partition configurations include different numbers of partitions and different arrangements of the partitions.

11. An apparatus for combining images, comprising:
an interface connectable to a network; and
processing circuitry configured to
send an image request to a plurality of selected users,
receive a plurality of contributed images from the plurality of selected users,
select a plurality of sub-images from the plurality of contributed images, wherein each sub-image corresponds to a sub-image area within the respective contributed image, and
combine the plurality of sub-images to create a combined image by arranging the plurality of sub-images within the combined image and blending a boundary region of each sub-image with the combined image.

12. The apparatus according to claim 11, further comprising:
a digital camera configured to acquire digital images; and
a memory configured to store the digital images acquired by the digital camera.

13. The apparatus according to claim 11, wherein the processing circuitry is further configured to divide the combined image into a plurality of partitions assigned to respective sub-images, and each sub-image area of the respective sub-image has a predefined shape within the respective contributed image determined by the respective partition of the combined image.

14. The apparatus according to claim 13, wherein the processing circuitry is further configured to continuously receive contributed images and continuously update the sub-images and the combined image as the contributed images are received, such that the combined image represents a real-time composite of the contributed images.

15. The apparatus according to claim 11, wherein the processing circuitry is further configured to
filter the plurality of sub-images to harmonize a color and a dark level of the plurality of sub-images with the combined image; and
adjust a shape and size of each of the plurality of sub-images to harmonize objects represented in the plurality of sub-images with shapes and sizes of objects represented in the combined image.

16. The apparatus according to claim 11, wherein the processing circuitry is further configured to
adjust a width of the boundary region of each sub-image; and
select a blending method whereby the boundary region of each sub-image is blended with the combined image.

17. The apparatus according to claim 11, wherein the processing circuitry is further configured to
detect faces in the contributed images;
define a region localized around each detected face as a facial area; and
select at least one of the facial areas as the respective sub-image area of the corresponding contributed image.

18. The apparatus according to claim 11, wherein the processing circuitry is further configured to
arrange the plurality of sub-images within the combined image to minimize overlap among the plurality of sub-images;
determine a time window during which the plurality of contributed images can be received, and not receiving contributed images outside of the time window;
select the plurality of selected users from a list of contacts; and
annotate the combined image.

19. The apparatus according to claim 11, wherein the processing circuitry is further configured to
select a configuration of the partitions of the combined image from a menu of partition configurations, wherein the partition configurations include different numbers of partitions and different arrangements of the partitions.

20. A non-transitory computer-readable medium storing executable instructions, wherein the instructions, when executed by processing circuitry, cause the processing circuitry to perform the method according to claim 1.
